(19) United States
(12) Patent Application Publication
(10) Pub. No.: US 2023/0274005 A1
(43) Pub. Date: Aug. 31, 2023

(54) INFORMATION PROCESSING APPARATUS, AND COMPUTER PROGRAM PRODUCT

(71) Applicant: KABUSHIKI KAISHA TOSHIBA, Tokyo (JP)

(72) Inventors: Hiroyoshi HARUKI, Kawasaki Kanagawa (JP); Fukutomo NAKANISHI, Sumida Tokyo (JP); Satoshi AOKI, Kawasaki Kanagawa (JP); Daiki ISHIHARA, Yokohama Kanagawa (JP)

(73) Assignee: KABUSHIKI KAISHA TOSHIBA, Tokyo (JP)

(21) Appl. No.: 17/899,374

(22) Filed: Aug. 30, 2022

(30) Foreign Application Priority Data
Feb. 28, 2022 (JP) 2022-029975

(51) Int. Cl. G06F 21/57; G06F 21/55

(52) U.S. Cl. CPC G06F 21/577; G06F 21/554

(57) ABSTRACT

According to an embodiment, an information processing apparatus includes a verification execution unit and a risk calculation unit. The verification execution unit attacks a verification environment in which at least one of attack countermeasures indicated by attack countermeasure information is applied to a verification target system by using each of a plurality of attack scenarios, and creates a possible attack scenario list that is a list of attack scenarios in which an attack has succeeded. The risk calculation unit calculates a risk value representing an evaluation result of the attack countermeasure applied to the verification environment, based on the possible attack scenario list.

### CROSS-REFERENCE TO RELATED APPLICATIONS

This application is based upon and claims the benefit of priority from Japanese Patent Application No. 2022-029975, filed on Feb. 28, 2022; the entire contents of which are incorporated herein by reference.

### FIELD

Embodiments described herein relate generally to an information processing apparatus, and a computer program product.

### BACKGROUND

Evaluation of an attack countermeasure suitable for an information system is performed. A method of evaluating an attack countermeasure against vulnerability of each device included in an information system and a method of evaluating an attack countermeasure for each attack activity have been proposed in the related arts.

### BRIEF DESCRIPTION OF THE DRAWINGS

FIG. 1 is a schematic diagram of an information processing apparatus;

FIG. 2A is a schematic diagram of a verification target system;

FIG. 2B is a schematic diagram of verification target system configuration information;

FIG. 3A is a schematic diagram of verification target system definition information;

FIG. 3B is a schematic diagram of verification target system definition information;

FIG. 3C is a schematic diagram of an attack scenario database (DB);

FIG. 3D is a schematic diagram of an attack countermeasure DB;

FIG. 3E is a schematic diagram of a condition setting DB;

FIG. 3F is a schematic diagram of verification environment definition information;

FIG. 3G is a schematic diagram of verification environment definition information;

FIG. 4A is a schematic diagram of a condition setting screen;

FIG. 4B is a schematic diagram of a display screen;

FIG. 5A is a schematic diagram of verification environment definition information;

FIG. 5B is a schematic diagram of verification environment definition information;

FIG. 6A is a schematic diagram of a verification environment;

FIG. 6B is a schematic diagram of verification environment configuration information;

FIG. 7 is a schematic diagram of a display screen;

FIG. 8 is a flowchart illustrating a flow of information processing;

FIG. 9A is a schematic diagram of a condition setting screen;

FIG. 9B is a schematic diagram of a condition setting DB;

FIG. 10 is a schematic diagram of a display screen;

FIG. 11 is a schematic diagram of an information processing apparatus;

FIG. 12 is a schematic diagram of a verification result DB;

FIG. 13A is a schematic diagram of a display screen;

FIG. 13B is a schematic diagram of a display screen;

FIG. 14 is a flowchart illustrating a flow of information processing;

FIG. 15 is a schematic diagram of an information processing apparatus;

FIG. 16A is a schematic diagram of an attack scenario DB;

FIG. 16B is a schematic diagram of a verification result DB;

FIG. 17 is a schematic diagram of an attack countermeasure DB;

FIG. 18 is a schematic diagram of a display screen;

FIG. 19 is a flowchart illustrating a flow of information processing;

FIG. 20 is a schematic diagram of an information processing apparatus;

FIG. 21 is a schematic diagram of an attack scenario template DB;

FIG. 22A is a schematic diagram of verification target system definition information;

FIG. 22B is a schematic diagram of verification target system definition information;

FIG. 23 is a schematic diagram of an attack countermeasure template;

FIG. 24 is a flowchart illustrating a flow of information processing; and

FIG. 25 is a hardware configuration diagram.

### DETAILED DESCRIPTION

According to an embodiment, an information processing apparatus includes a verification execution unit and a risk calculation unit. The verification execution unit attacks a verification environment in which at least one of attack countermeasures indicated by attack countermeasure information is applied to a verification target system by using each of a plurality of attack scenarios, and creates a possible attack scenario list that is a list of attack scenarios in which an attack has succeeded. The risk calculation unit calculates a risk value representing an evaluation result of the attack countermeasure applied to the verification environment, based on the possible attack scenario list.

Hereinafter, an information processing apparatus, an information processing method, and an information processing program according to the present embodiment will be described in detail with reference to the accompanying drawings.

Note that, in the following description of each embodiment, portions denoted by the same reference signs have substantially the same functions, and a description of overlapping portions will be omitted as appropriate.

### First Embodiment

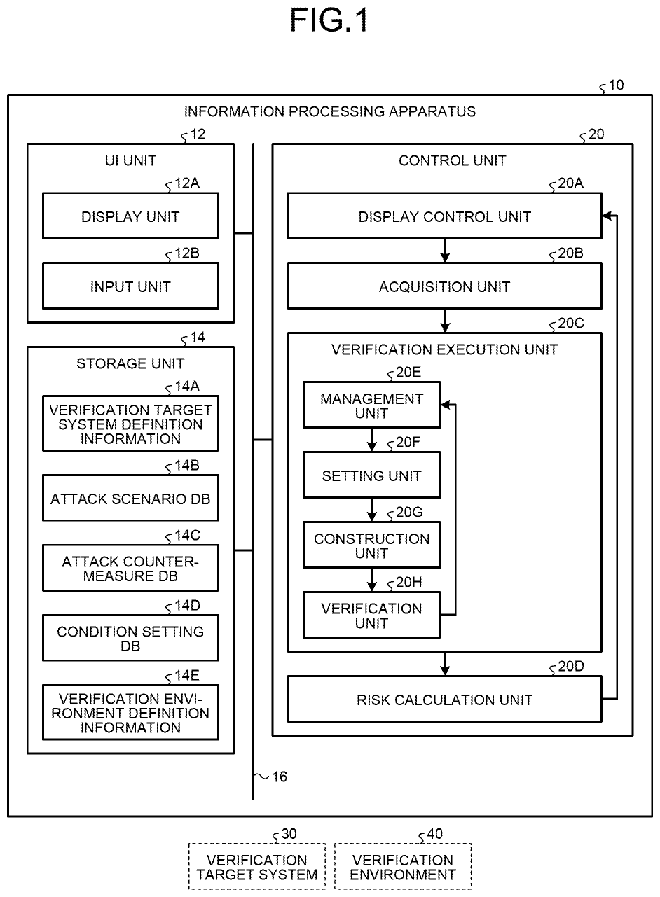

FIG. 1 is a schematic diagram of an example of an information processing apparatus 10 according to the present embodiment.

The information processing apparatus 10 is an information processing apparatus that constructs a verification environment 40, in which an attack countermeasure is applied to a verification target system 30, and evaluates the attack countermeasure by performing a plurality of attacks on the constructed verification environment 40.

The verification target system 30 is a verification target information system for which verification of whether or not an attack succeeds is to be performed. The verification environment 40 is an environment constructed by applying an attack countermeasure to the verification target system 30. The verification environment 40 may be a real system or a virtual system. Details of the verification target system 30 and the verification environment 40 will be described later.

The information processing apparatus 10 includes a user interface (UI) unit 12, a storage unit 14, and a control unit 20. The UI unit 12, the storage unit 14, and the control unit 20 are communicably connected via a bus 16 or the like.

The UI unit 12 has a display function of displaying various types of information and an input function of receiving an operation instruction from a user. In the present embodiment, the UI unit 12 includes a display unit 12A and an input unit 12B. The display unit 12A is a display that displays various types of information. The input unit 12B receives an operation input from the user. The input unit 12B is, for example, a pointing device such as a mouse, a keyboard, or the like. Note that the UI unit 12 may be a touch panel in which the display unit 12A and the input unit 12B are integrated.

The storage unit 14 stores various types of information. The storage unit 14 may be a storage device provided outside the information processing apparatus 10. For example, the storage unit 14 may be mounted on an external information processing apparatus connected to the information processing apparatus 10 via a network or the like.

In the present embodiment, the storage unit 14 stores verification target system definition information 14A, an attack scenario database (DB) 14B, an attack countermeasure DB 14C, a condition setting DB 14D, and verification environment definition information 14E.

The verification target system definition information 14A is information indicating a definition of a configuration of the verification target system 30.

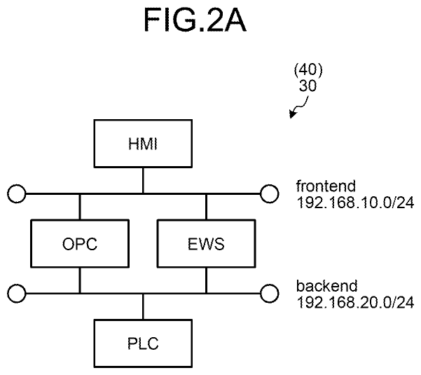

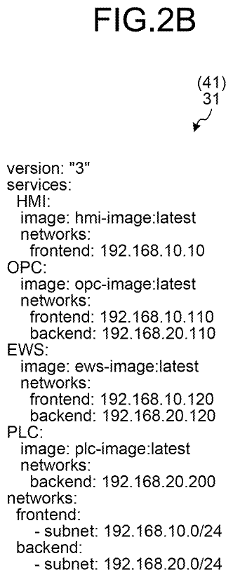

FIG. 2A is a schematic diagram illustrating an example of a configuration of the verification target system 30. The verification target system 30 includes one or more devices and a network that connects the devices.

FIG. 2A illustrates a form in which the verification target system 30 includes a human machine interface (HMI), object linking and embedding (OLE) for process control (OPC), an engineering workstation (EWS), and a programmable logic controller (PLC) as the devices by way of example.

Furthermore, FIG. 2A illustrates a form in which the verification target system 30 includes 192.168.10.0/24 (frontend) and 192.168.20.0/24 (backend) as network segments by way of example. In the example illustrated in FIG. 2A, the HMI, the OPC, and the EWS are connected with the frontend, and the PLC, the OPC, and the EWS are connected with the backend.

FIG. 2B is a schematic diagram of an example of verification target system configuration information 31. The verification target system configuration information 31 is information indicating the configuration of the verification target system 30.

FIG. 2B illustrates a schematic diagram of the verification target system configuration information 31 in a case where the verification target system 30 is constructed by a mechanism called a container. The verification target system configuration information 31 includes device information, which is information on a device included in the verification target system 30, and network information, which is information indicating a network included in the verification target system 30.

The verification target system configuration information 31 illustrated in FIG. 2B indicates that the verification target system 30 has a service with “a name “HMI”, a network address “192.168.10.10”, and an image file “hmi-image:latest” used to activate the service” and has a network with “a name “frontend” and a subnet “192.168.10.0/24””.

The verification target system definition information 14A is information indicating a definition of the configuration of the verification target system 30 indicated by the verification target system configuration information 31.

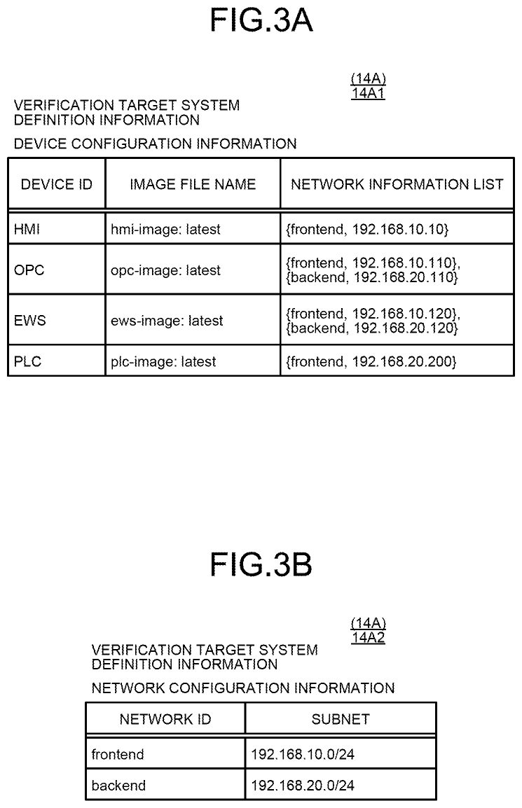

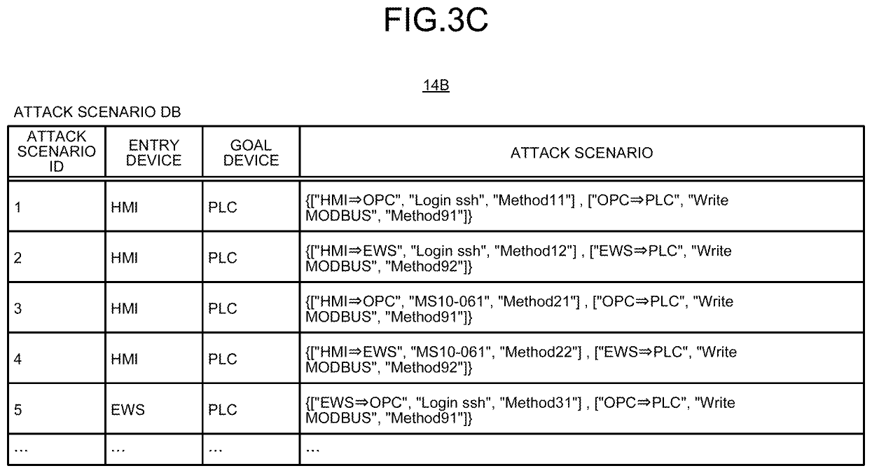

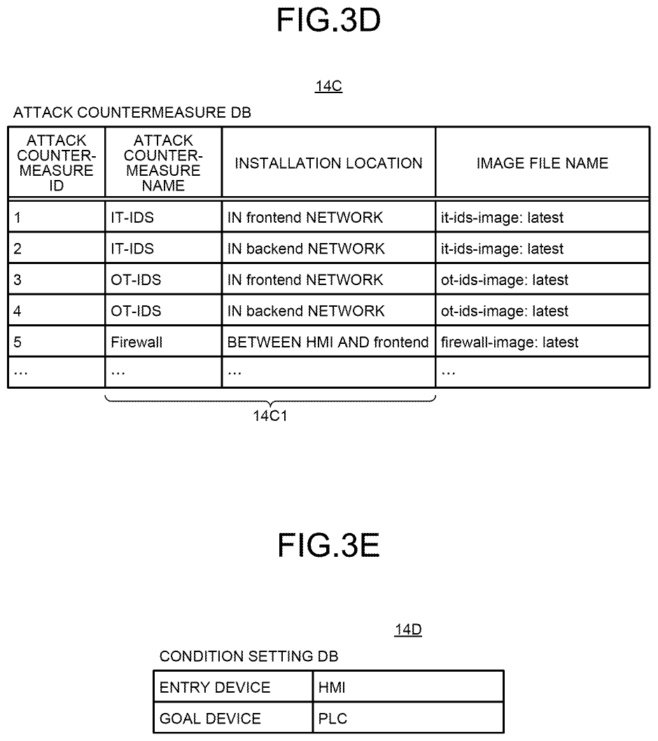

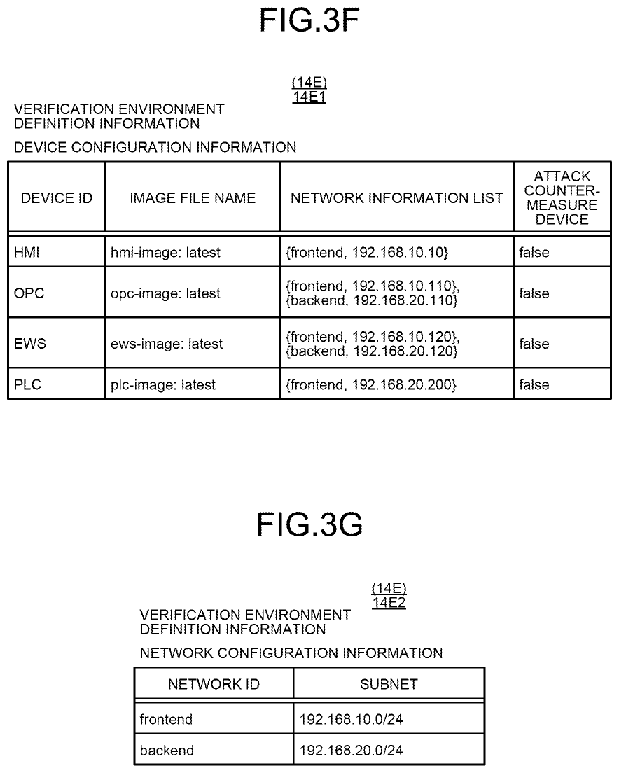

FIGS. 3A and 3B are schematic diagrams illustrating examples of a data configuration of the verification target system definition information 14A. The verification target system definition information 14A includes device configuration information 14A1 and network configuration information 14A2.

FIG. 3A is a schematic diagram illustrating an example of a data configuration of the device configuration information 14A1. The device configuration information 14A1 is information indicating a configuration of a device included in the verification target system 30. The device configuration information 14A1 is, for example, a database in which a device ID, an image file name, and a network information list are associated with each other. The data format of the device configuration information 14A1 is not limited to the database.

The device ID is identification information of a device. The image file name is a file name that is used when constructing the verification environment 40 including a device identified with a corresponding device ID and serves as a base of the device. The network information list is information indicating a list of pieces of network information of devices identified with corresponding device IDs. The network information is represented by, for example, a combination of a network ID and a network address.

FIG. 3B is a schematic diagram illustrating an example of a data configuration of the network configuration information 14A2. The network configuration information 14A2 is information indicating a network configuration of the verification target system 30. The network configuration information 14A2 is, for example, a database in which a network ID and a subnet are associated with each other. The network ID is identification information of a network. The data format of the network configuration information 14A2 is not limited to the database.

The device configuration information 14A1 illustrated in FIG. 3A indicates that the verification target system 30 having the device configuration indicated by the device configuration information 14A1 includes a device corresponding to a device ID “HMI”, an image file name “hmi-image:latest”, a network ID “frontend”, and a network address “192.168.10.10”, and the like.

Furthermore, the network configuration information 14A2 illustrated in FIG. 3B indicates that the verification target system 30 having the network configuration indicated by the network configuration information 14A2 includes a network with a network ID “frontend” and a subnet “192.168.10.0/24”, and the like.

FIG. 3C is a schematic diagram illustrating an example of a data configuration of the attack scenario DB 14B. A plurality of attack scenarios are registered in the attack scenario DB 14B.

The attack scenario DB 14B is, for example, a database in which an attack scenario ID, an entry device, a goal device, and an attack scenario are associated with each other. The data format of the attack scenario DB 14B is not limited to the database.

The attack scenario ID is identification information of the attack scenario. The entry device is information indicating a device serving as an entrance for an attack. In a case where an attack has already entered, the entry device is information indicating an attack source device through which the attack further enters. The goal device is information indicating a device that is a final target of the attack. That is, in a case where the attack reaches the goal device, the attack is regarded as successful.

The attack scenario is a scenario in which an attack content is defined. The attack content is represented by a name of an attack source, a name of an attack destination, attack means, a specific attack method, and the like. One attack scenario includes a combination of one or more attack contents.

The attack scenario DB 14B illustrated in FIG. 3C includes, as an attack scenario identified with an attack scenario ID “1”, for example, an attack scenario in which the entry device is “HMI”, the goal device is “PLC”, the attack means “Login ssh” and the attack method “Method11” are used from the HMI toward the OPC, and then the attack means “Write MODBUS” and the attack method “Method91” are used from the OPC toward the PLC.

FIG. 3D is a schematic diagram illustrating an example of a data configuration of the attack countermeasure DB 14C. The attack countermeasure DB 14C includes a plurality of pieces of attack countermeasure information 14C1.

The attack countermeasure DB 14C is, for example, a database in which an attack countermeasure ID, an attack countermeasure name, an installation location, and an image file name are associated with each other. The data format of the attack countermeasure DB 14C is not limited to the database.

The attack countermeasure ID is identification information of an attack countermeasure indicated by the attack countermeasure information 14C1. The attack countermeasure information 14C1 includes information indicating an attack countermeasure name and an installation location. The attack countermeasure name is a name of the attack countermeasure. The attack countermeasure name indicates the content of the attack countermeasure corresponding to the attack countermeasure name. The installation location of the attack countermeasure indicates an application destination of the attack countermeasure for the verification target system 30. The attack countermeasure information 14C1 may include an image file name. The image file name is a file name that is used when constructing the verification environment 40 in which the attack countermeasure having the corresponding attack countermeasure name is applied, and serves as a base of the attack countermeasure.

The attack countermeasure DB 14C illustrated in FIG. 3D includes, as the attack countermeasure information 14C1 identified with an attack countermeasure ID “1”, an attack countermeasure name “IT-IDS” and an installation location “in frontend network”. In addition, in FIG. 3D, an image file name “it-ids-image:latest” corresponding to the attack countermeasure information 14C1 is included.

In the present embodiment, a description will be given on the assumption that the verification target system definition information 14A, the attack scenario DB 14B, and the attack countermeasure DB 14C are stored in the storage unit 14 in advance.

FIG. 3E is a schematic diagram illustrating an example of a data configuration of the condition setting DB 14D. The condition setting DB 14D is a database for registering condition setting information. The condition setting information is information including the name of the entry device and the name of the goal device which are conditions for operating the information processing apparatus. The condition setting DB 14D is used to register setting of each of the entry device and the goal device of the attack on the verification environment 40. The data format of the condition setting DB 14D is not limited to the database.

FIG. 3E illustrates a state in which the condition setting information including the entry device “HMI” and the goal device “PLC” is set in the condition setting DB 14D. In other words, the example illustrated in FIG. 3E illustrates a state in which setting is made assuming an attack with the entry device “HMI” and the goal device “PLC”.

The condition setting DB 14D is set by the control unit 20 to be described later according to an operation instruction or the like from the user (to be described later in detail).

FIGS. 3F and 3G are schematic diagrams illustrating examples of a data configuration of the verification environment definition information 14E. The verification environment definition information 14E is information indicating a definition of the configuration of the verification environment 40. The verification environment definition information 14E includes device configuration information 14E1 and network configuration information 14E2.

FIG. 3F is a schematic diagram illustrating an example of a data configuration of the device configuration information 14E1. The device configuration information 14E1 is information indicating the configuration of the device included in the verification environment 40. The device configuration information 14E1 is, for example, a database in which a device ID, an image file name, a network information list, and an attack countermeasure device are associated with each other. The data format of the device configuration information 14E1 is not limited to the database.

The attack countermeasure device is information indicating whether or not the device identified with the corresponding device ID is a device installed for attack countermeasures. In the present embodiment, attack countermeasure device “false” indicates that the device is not a device installed for attack countermeasures. On the other hand, attack countermeasure device “true” indicates that the device is a device installed for attack countermeasures.

FIG. 3G is a schematic diagram illustrating an example of a data configuration of the network configuration information 14E2. The network configuration information 14E2 is information indicating a configuration of a network of the verification environment 40. The network configuration information 14E2 is, for example, a database in which a network ID and a subnet are associated with each other. The data format of the network configuration information 14E2 is not limited to the database.

FIG. 3F illustrates that the verification environment 40 having the device configuration indicated by the device configuration information 14E1 includes, for example, a device corresponding to a device ID “HMI”, an image file name “hmi-image:latest”, a network ID “frontend”, a network address “192.168.10.10”, and attack countermeasure device “false”.

In addition, FIG. 3G illustrates that the verification environment 40 having the network configuration indicated by the network configuration information 14E2 includes, for example, a network corresponding to a network ID “frontend” and a subnet “192.168.10.0/24”.

The verification environment definition information 14E is updated by the control unit 20 described later (details will be described later).

Returning to FIG. 1, the description will be continued. Next, the control unit 20 will be described. The control unit 20 performs information processing in the information processing apparatus 10. The control unit 20 includes a display control unit 20A, an acquisition unit 20B, a verification execution unit 20C, and a risk calculation unit 20D. The verification execution unit 20C includes a management unit 20E, a setting unit 20F, a construction unit 20G, and a verification unit 20H.

The display control unit 20A, the acquisition unit 20B, the verification execution unit 20C, the risk calculation unit 20D, the management unit 20E, the setting unit 20F, the construction unit 20G, and the verification unit 20H are implemented by, for example, one or more processors. For example, each of the above-described units may be implemented by causing a processor such as a central processing unit (CPU) to execute a program, that is, by software. Each of the above-described units may be implemented by a processor such as a dedicated IC, that is, hardware. Each of the above-described units may be implemented by using software and hardware in combination. Further, in a case of using a plurality of processors, each processor may implement one of the respective units, or may implement two or more of the respective units. Furthermore, at least one of the above-described units may be provided in an external information processing apparatus connected to the information processing apparatus 10 via a network.

The display control unit 20A controls display of various types of information on the display unit 12A. The acquisition unit 20B acquires various types of information input by the user operating the input unit 12B.

The verification execution unit 20C attacks the verification environment 40, in which at least one of attack countermeasures indicated by the attack countermeasure information 14C1 is applied to the verification target system 30, by using each of a plurality of attack scenarios, and creates a possible attack scenario list that is a list of attack scenarios in which the attack has succeeded. In the present embodiment, a form in which the verification execution unit 20C constructs the verification environment 40 and uses it for verification will be described as an example.

Hereinafter, a series of processings of constructing the verification environment 40 to which the attack countermeasure is applied, attacking the verification environment 40, and creating the possible attack scenario list will be referred to as verification or verification execution in some cases. In addition, a series of processings performed by the verification execution unit 20C may be referred to as verification processing.

The verification execution unit 20C includes the management unit 20E, the setting unit 20F, the construction unit 20G, and the verification unit 20H.

The management unit 20E manages the verification processing performed by the verification execution unit 20C.

In the present embodiment, the management unit 20E transmits, to the display control unit 20A, a request for displaying a condition setting screen for receiving the setting of the entry device and the goal device of the attack on the verification target system 30. The display control unit 20A that has received the request for displaying the condition setting screen displays the condition setting screen on the display unit 12A.

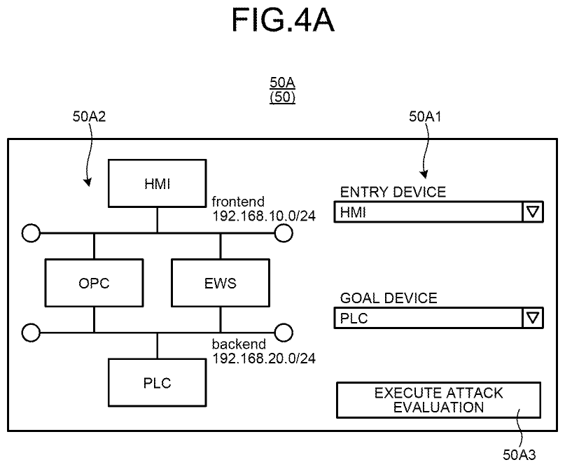

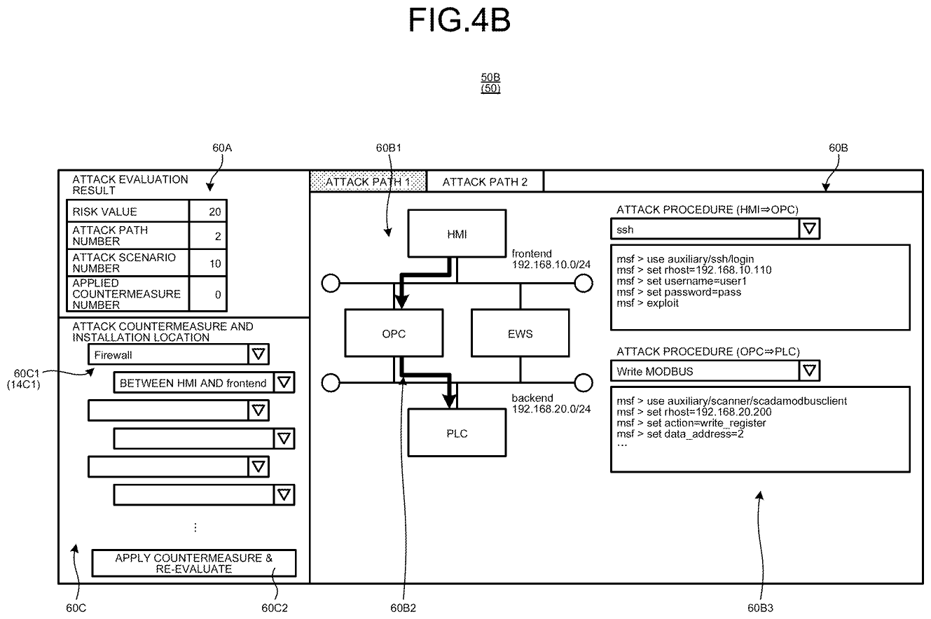

FIG. 4A is a schematic diagram illustrating an example of a condition setting screen 50A. The condition setting screen 50A is an example of a display screen 50 displayed on the display unit 12A.

The condition setting screen 50A is an input screen for receiving the setting of the entry device and the goal device of the attack on the verification target system 30 from the user. For example, the condition setting screen 50A includes a condition input field 50A1, a configuration image 50A2 of the verification target system 30, and an execution button 50A3. The execution button 50A3 is an instruction button for instructing execution of attack evaluation.

For example, it is assumed that the verification target system 30 has the configuration illustrated in FIG. 2A. In addition, it is assumed that the storage unit 14 stores the verification target system definition information 14A illustrated in FIGS. 3A and 3B in advance as the verification target system definition information 14A of the verification target system 30 illustrated in FIG. 2A.

In this case, for example, the display control unit 20A displays, as the configuration image 50A2 of the verification target system 30, an image representing the verification target system definition information 14A stored in the storage unit 14. For example, the display control unit 20A creates and displays, as the configuration image 50A2 of the verification target system 30, a configuration image in which a device identified with a device ID included in the device configuration information 14A1 of the verification target system definition information 14A and a network indicated by the network configuration information 14A2 are connected.

Therefore, as illustrated in FIG. 4A, the condition setting screen 50A displays the configuration image 50A2 of the verification target system 30 indicated by the verification target system definition information 14A.

The condition input field 50A1 is a field for the input of the entry device and the goal device from the user.

The display control unit 20A displays, in a selectable manner, each device ID registered in the verification target system definition information 14A in the condition input field 50A1 as an option of the entry device and the goal device. For example, the display control unit 20A displays, in a selectable manner, each of the HMI, the OPC, the EWS, and the PLC, which are the device IDs of the devices included in the verification target system 30, in the condition input field 50A1 as the entry device and the goal device.

The user can easily confirm the outline of the devices included in the verification target system 30 and the network by viewing the configuration image 50A2 of the verification target system 30 displayed on the condition setting screen 50A.

In addition, the user operates the input unit 12B while viewing the condition setting screen 50A displayed on the display unit 12A to select and input a desired entry device and a desired goal device in the condition input field 50A1.

The user performs these operations to input the condition setting information indicating the entry device and the goal device through the condition setting screen 50A. Then, the user operates the execution button 50A3 according to the operation instruction of the input unit 12B. Through these operations, the user can select a device that may be attacked as the entry device, select an important device in the verification target system 30 as the goal device, and instruct the information processing apparatus 10 to verify whether or not the attack that has entered through the entry device reaches the goal device.

Once the user operates the condition input field 50A1 and the execution button 50A3 by using the input unit 12B, the acquisition unit 20B acquires the input condition setting information.

Returning to FIG. 1, the description will be continued. The management unit 20E registers the condition setting information input via the condition input field 50A1 of the condition setting screen 50A in the condition setting DB 14D. Therefore, as illustrated in FIG. 3E, the condition setting DB 14D includes information indicating the entry device and the goal device included in the condition setting information input by the user.

The setting unit 20F sets the verification environment definition information 14E of the verification environment 40 to be constructed by the construction unit 20G to be described later, and stores the verification environment definition information 14E in the storage unit 14.

First, processing performed by each functional unit of the control unit 20 will be described on the assumption that the verification target system 30 to which no attack countermeasure is applied is set as the verification environment 40.

In this case, the setting unit 20F sets the verification target system definition information 14A as the verification environment definition information 14E and stores the verification target system definition information 14A in the storage unit 14. In addition, the setting unit 20F sets “false” indicating that the device is not a device installed for attack countermeasures in the field of the attack countermeasure device corresponding to each device ID set in the verification environment definition information 14E.

In this case, for example, as illustrated in FIGS. 3F and 3G, the verification target system definition information 14A illustrated in FIGS. 3A and 3B is set as the verification environment definition information 14E, and attack countermeasure device “false” is set in association with all the device IDs.

Returning to FIG. 1, the description will be continued. The construction unit 20G constructs the verification environment 40 by using the verification environment definition information 14E.

The construction unit 20G generates verification environment configuration information 41 by using the device configuration information 14E1 and the network configuration information 14E2 included in the verification environment definition information 14E. The verification environment configuration information 41 indicates configuration information of the verification environment 40 in a case where the verification environment 40 is constructed by a mechanism called a container. Here, in a case where the verification target system 30 to which no attack countermeasure is applied is set as the verification environment 40, the construction unit 20G generates, for example, the verification target system configuration information 31 illustrated in FIG. 2B as the verification environment configuration information 41.

Then, the construction unit 20G constructs the verification environment 40 by using the verification environment configuration information 41. For example, the construction unit 20G constructs the verification environment 40 by executing a docker-compose command. In a case where the verification target system 30 to which no attack countermeasure is applied is set as the verification environment 40, the construction unit 20G constructs the verification environment 40 illustrated in FIG. 2A by using the verification environment configuration information 41 illustrated in FIG. 2B, for example.

Returning to FIG. 1, the description will be continued. The verification unit 20H attacks the verification environment 40 by using each of the plurality of attack scenarios, and creates the possible attack scenario list that is a list of attack scenarios in which the attack has succeeded.

Specifically, the verification unit 20H specifies the entry device and the goal device indicated by the condition setting information set in the condition setting DB 14D. Then, the verification unit 20H specifies a plurality of attack scenarios corresponding to a combination of the specified entry device and the specified goal device from the attack scenario DB 14B.

For example, it is assumed that the condition setting DB 14D includes condition setting information indicating the entry device “HMI” and the goal device “PLC” as illustrated in FIG. 3E. In addition, it is assumed that the storage unit 14 stores the attack scenario DB 14B illustrated in FIG. 3C in advance.

In this case, the verification unit 20H specifies, from the attack scenario DB 14B, a plurality of attack scenarios corresponding to a combination of the entry device and the goal device set in the condition setting DB 14D among the combinations of the entry devices and the goal devices registered in the attack scenario DB 14B. Note that the attack scenario DB 14B is assumed to include a plurality of attack scenarios in association with one combination of the entry device and the goal device in advance.

Then, the verification unit 20H attacks the verification environment 40 constructed by the construction unit 20G by through the specified entry device as an entrance. The verification unit 20H may attack the verification environment 40 through the entry device as an entrance by using account information, or may attack the verification environment 40 through the entry device as an entrance by using the vulnerability of the entry device.

Then, the verification unit 20H performs an attack having an attack content represented by an attack scenario on the verification environment 40 for each of the plurality of specified attack scenarios, and holds the attack scenario as a successful attack scenario in a case where the attack has reached the goal device.

Then, once the execution of all of the plurality of specified attack scenarios is completed, the verification unit 20H creates the possible attack scenario list that is a list of successful attack scenarios.

Returning to FIG. 1, the description will be continued. The management unit 20E outputs the possible attack scenario list created by the verification unit 20H and the verification environment definition information 14E of the verified verification environment 40 to the risk calculation unit 20D.

The risk calculation unit 20D calculates a risk value representing an evaluation result of an attack countermeasure applied to the verification environment 40 based on the possible attack scenario list received from the management unit 20E.

For example, the risk calculation unit 20D calculates the attack path number which is the number of paths through which the attack on the verification environment 40 has succeeded, and the attack scenario number which is the number of attack scenarios in which the attack has succeeded, based on the possible attack scenario list. Then, the risk calculation unit 20D calculates the risk value based on the attack path number and the attack scenario number. In the present embodiment, a case where the smaller the risk value, the higher the effect of the attack countermeasure, and the larger the risk value, the lower the effect of the attack countermeasure will be described as an example.

For example, the risk calculation unit 20D calculates, as the risk value, a result of multiplication of the attack path number and the attack scenario number. It is assumed that the attack path number is two and the attack scenario number is 10. In this case, the risk calculation unit 20D calculates as the risk value, 20 that is the multiplication result. Note that the risk calculation unit 20D may calculate, as the risk value, a result of adding the attack path number and the attack scenario number, and is not limited to a form in which a multiplication result is used.

Once the risk value is calculated by the risk calculation unit 20D, the display control unit 20A displays a verification result screen including the risk value calculated by the risk calculation unit 20D on the display unit 12A.

FIG. 4B is a schematic diagram of an example of a display screen 50B. The display screen 50B is an example of the display screen 50. The display screen 50B includes a verification result screen 60A.

The verification result screen 60A includes at least the risk value. Specifically, the verification result screen 60A including the risk value calculated by the risk calculation unit 20D and at least one of the applied countermeasure number which is the number of attack countermeasures applied to the verification environment 40, the attack path number which is the number of attack paths through which the attack on the verification environment 40 has succeeded, or the attack scenario number which is the number of attack scenarios in which the attack has succeeded, is displayed as the verification result screen 60A.

For example, the display control unit 20A acquires the risk value, and the attack path number and the attack scenario number used to calculate the risk value from the risk calculation unit 20D. Then, the display control unit 20A displays the risk value, the attack path number, and the attack scenario number acquired from the risk calculation unit 20D on the verification result screen 60A.

In addition, the display control unit 20A calculates the number of attack countermeasure devices “true” registered in the verification environment definition information 14E as the applied countermeasure number, and displays the number on the verification result screen 60A. In a case where the verification target system 30 to which no attack countermeasure is applied is set as the verification environment 40, “false” indicating that the device is not a device installed for attack countermeasures is set in the field of the attack countermeasure device corresponding to each device ID included in the verification environment definition information 14E. Therefore, in this case, the display control unit 20A displays “0” as the applied countermeasure number on the verification result screen 60A.

In addition, the display control unit 20A further displays an attack path screen 60B and a selection screen 60C on the display unit 12A.

FIG. 4B illustrates a form in which the display screen 50B includes the verification result screen 60A, the attack path screen 60B, and the selection screen 60C as an example. Note that the display control unit 20A may display the verification result screen 60A, the attack path screen 60B, and the selection screen 60C on the display unit 12A as separate display screens.

The attack path screen 60B is a screen showing the attack path. The attack path screen 60B includes at least one of a configuration image 60B1 of the verification environment 40, a successful attack path image 60B2, or an attack procedure 60B3.

The configuration image 60B1 of the verification environment 40 is an image representing the configuration of the verification environment 40 verified by the verification unit 20H. For example, the configuration image 60B1 of the verification environment 40 includes an image representing at least one of the device configuration of the verification environment 40, the network configuration of the verification environment 40, or the attack countermeasure applied to the verification environment 40.

The successful attack path image 60B2 is an image representing an attack path through which the attack has succeeded and which is indicated by the possible attack scenario list. For example, the successful attack path image 60B2 is displayed by arranging an arrow or the like representing an attack path through which the attack has succeeded on the configuration image 60B1 of the verification environment 40.

The attack procedure 60B3 is information indicating an attack procedure along the attack path through which the attack has succeeded.

The display control unit 20A generates an image schematically representing the configuration of the verification environment 40 constructed using the verification environment definition information 14E, and displays the generated image on the attack path screen 60B as the configuration image 60B1 of the verification environment 40. For example, the display control unit 20A creates and displays, as the configuration image 60B1 of the verification environment 40, a configuration image in which a device identified with a device ID included in the device configuration information 14E1 of the verification environment definition information 14E and a network indicated by the network configuration information 14E2 are connected.

In addition, the display control unit 20A arranges the successful attack path image 60B2 represented by an arrow or the like on the configuration image 60B1 of the verification environment 40. Any method may be used as long as the attack path can be recognized. Further, the display control unit 20A displays, on the attack path screen 60B, the attack procedure 60B3 along the attack path through which the attack has succeeded and which is indicated by the possible attack scenario list.

Through these processings, the display control unit 20A displays the display screen 50B including the attack path screen 60B on the display unit 12A.

The selection screen 60C is a selection screen for selection of the attack countermeasure information 14C1 including the attack countermeasure name of the attack countermeasure and the installation location of the attack countermeasure for the verification target system 30.

In the present embodiment, the display control unit 20A reads one piece of attack countermeasure information 14C1 indicating a correspondence between the attack countermeasure name and the installation location from the attack countermeasure DB 14C (see FIG. 3D). Then, the display control unit 20A displays a pair of the attack countermeasure name and the installation location included in the one piece of read attack countermeasure information 14C1 in a selection field 60C1 in a selectable manner. FIG. 4B is an example of a case where the attack countermeasure name “Firewall” and the installation location “between HMI and frontend” are displayed as options. That is, in the present embodiment, the display control unit 20A displays one piece of attack countermeasure information 14C1 including a pair of one attack countermeasure name and one installation location on the selection screen 60C in a selectable manner.

The user operates the input unit 12B while viewing the selection screen 60C to select the name of the attack countermeasure to be applied to the verification target system 30 and the installation location of the attack countermeasure. With this selection processing, the user inputs the attack countermeasure information 14C1 of a desired attack countermeasure.

Then, it is assumed that the user further operates an execution button 60C2 by operating the input unit 12B. The execution button 60C2 is a button image for instructing execution of verification of the verification environment 40 in which the attack countermeasure indicated by the selected attack countermeasure information 14C1 is applied.

Once the user operates the execution button 60C2 by operating the input unit 12B, the acquisition unit 20B acquires the input attack countermeasure information 14C1 and the verification execution instruction.

Returning to FIG. 1, the description will be continued. Next, processing performed by each functional unit of the control unit 20 will be described on the assumption that the verification target system 30 to which the attack countermeasure is applied is set as the verification environment 40.

Once the acquisition unit 20B acquires the attack countermeasure information 14C1 and the verification execution instruction from the input unit 12B, the verification execution unit 20C sets the verification target system 30 to which the attack countermeasure indicated by the input attack countermeasure information 14C1 is applied as the verification environment 40 and executes the verification processing.

In detail, the verification execution unit 20C constructs the verification environment 40 in which the attack countermeasure indicated by the attack countermeasure information 14C1 is applied based on the attack countermeasure information 14C1 selected via the selection screen 60C, and creates the attacker scenario.

Specifically, the setting unit 20F included in the verification execution unit 20C clears all pieces of information set in the verification environment definition information 14E. Then, the setting unit 20F reads the verification target system definition information 14A from the storage unit 14, and changes the device configuration information and the network configuration information according to the attack countermeasure indicated by the attack countermeasure information 14C1 that has been selected via the selection screen 60C. Then, the setting unit 20F sets the changed device configuration information and network configuration information as the verification environment definition information 14E.

For example, it is assumed that the storage unit 14 stores the verification target system definition information 14A illustrated in FIGS. 3A and 3B. In addition, it is assumed that the attack countermeasure information 14C1 that has been selected via the selection screen 60C includes the attack countermeasure name “Firewall” and the installation location “between HMI and frontend” as illustrated in FIG. 4B.

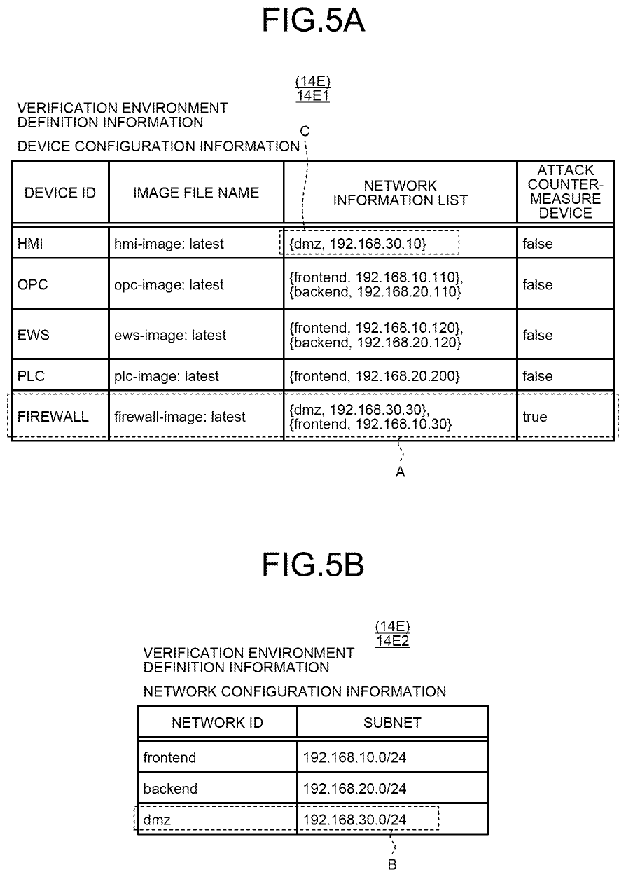

In this case, the setting unit 20F sets the verification environment definition information 14E illustrated in FIGS. 5A and 5B.

FIGS. 5A and 5B are schematic diagrams illustrating an example of a data configuration of the verification environment definition information 14E to which the attack countermeasure indicated by the selected attack countermeasure information 14C1 is applied. FIG. 5A is a schematic diagram illustrating an example of the data configuration of the device configuration information 14E1 included in the verification environment definition information 14E. FIG. 5B is a schematic diagram illustrating an example of the data configuration of the network configuration information 14E2 included in the verification environment definition information 14E.

The setting unit 20F sets the device configuration information 14A1 included in the verification target system definition information 14A illustrated in FIG. 3A as the device configuration information 14E1 (see FIG. 5A), and sets the network configuration information 14A2 included in the verification target system definition information 14A illustrated in FIG. 3B as the network configuration information 14E2 (see FIG. 5B).

Further, the setting unit 20F acquires, from the attack countermeasure DB 14C, an image file name corresponding to the attack countermeasure name and the installation location included in the attack countermeasure information 14C1 selected via the selection screen 60C. Here, it is assumed that the image file name “firewall-image:latest” is acquired.

Then, the setting unit 20F adds a network called dmz (192.168.30.0/24) between the HMI and the frontend in order to install the attack countermeasure indicated by the attack countermeasure name “Firewall” at the installation location of the attack countermeasure, “between HMI and frontend”. Specifically, as illustrated in FIG. 5B, the setting unit 20F sets a network ID “dmz” and a subnet “192.168.30.0/24” in association with each other in the network configuration information 14E2 (see a part denoted by Reference Sign B in FIG. 5B).

Further, the setting unit 20F sets a device ID “FIREWALL”, an image file name “firewall-image:latest”, and a network information list indicating that network connection destinations are the dmz network (192.168.30.30) and the frontend network (102.168.10.30) in association with one another in the device configuration information 14E1 (see a part denoted by Reference Sign A in FIG. 5A). In addition, the setting unit 20F changes the network connection destination of the device ID “HMI” from the frontend network (192.168.10.10) to the dmz network (192.168.30.10) (see a part denoted by Reference Sign C in FIG. 5A).

In addition, the setting unit 20F sets “true” indicating that the device is a device installed for attack countermeasures in the field of the attack countermeasure device corresponding to the device ID “FIREWALL” in the device configuration information 14E1. The setting unit 20F sets “false” indicating that the device is not a device installed for attack countermeasures in the field of the attack countermeasure device corresponding to a device ID other than the device ID “FIREWALL”.

With these processings, the setting unit 20F sets the verification environment definition information 14E indicating the verification environment 40 in which the attack countermeasure is applied to the verification target system 30 according to the attack countermeasure indicated by the attack countermeasure information 14C1 selected via the selection screen 60C.

Returning to FIG. 1, the description will be continued. The construction unit 20G constructs the verification environment 40 by using the set verification environment definition information 14E.

Similarly to the above, the construction unit 20G generates the verification environment configuration information 41 by using the device configuration information 14E1 and the network configuration information 14E2 included in the verification environment definition information 14E. Specifically, the construction unit 20G generates the verification environment configuration information 41 in which the attack countermeasure is applied by using the verification environment definition information 14E of the verification environment 40 in which the attack countermeasure indicated by the selected attack countermeasure information 14C1 is applied. Then, the construction unit 20G constructs the verification environment 40 by using the generated verification environment configuration information 41. For example, the construction unit 20G constructs the verification environment 40 by executing a docker-compose command.

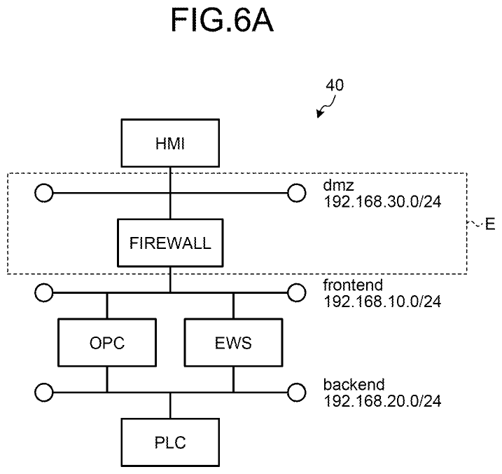

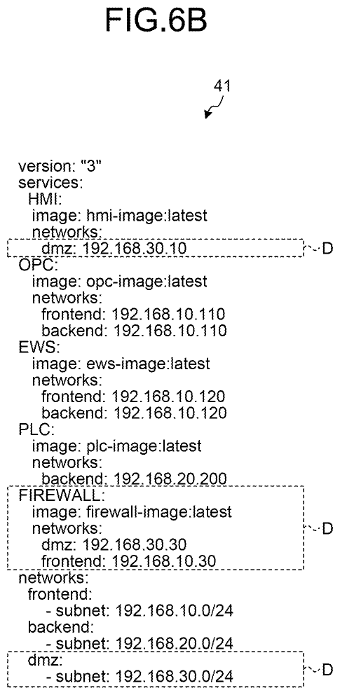

FIG. 6A is a schematic diagram illustrating an example of a configuration of the verification environment 40 to which the attack countermeasure is applied. FIG. 6B is a schematic diagram of an example of the verification environment configuration information 41 in a case where the verification environment 40 to which the attack countermeasure is applied is constructed by a mechanism called a container.

FIGS. 6A and 6B illustrate an example of the verification environment configuration information 41 and the verification environment 40 generated by using the verification environment definition information 14E illustrated in FIGS. 5A and 5B.

The construction unit 20G generates the verification environment configuration information 41 illustrated in FIG. 6B by using the verification environment definition information 14E indicating the verification environment 40 in which the attack countermeasure indicated by the attack countermeasure information 14C1 selected via the selection screen 60C is applied. As illustrated in FIG. 6B, the verification environment configuration information 41 includes information indicating the applied attack countermeasure (see a region denoted by Reference Sign D in FIG. 6B).

Then, the construction unit 20G constructs the verification environment 40 by using the verification environment configuration information 41 illustrated in FIG. 6B. For example, the construction unit 20G constructs the verification environment 40 illustrated in FIG. 6A by executing the docker-compose command. As illustrated in FIG. 6A, the verification environment 40 includes the applied attack countermeasure (see a region denoted by Reference Sign E in FIG. 6A).

Returning to FIG. 1, the description will be continued. Then, once the new verification environment 40 is constructed by the construction unit 20G, the control unit 20 performs processing similar to the above. That is, every time the new verification environment 40 is constructed by the construction unit 20G, the control unit 20 performs processing similar to the above.

Specifically, the verification unit 20H attacks the verification environment 40 constructed by the construction unit 20G by using each of the plurality of attack scenarios, and creates the possible attack scenario list that is a list of attack scenarios in which the attack has succeeded. The management unit 20E outputs the possible attack scenario list created by the verification unit 20H and the verification environment definition information 14E of the verification environment 40 to the risk calculation unit 20D.

The risk calculation unit 20D calculates a risk value representing an evaluation result of an attack countermeasure applied to the verification environment 40 based on the possible attack scenario list received from the verification execution unit 20C.

For example, it is assumed that the possible attack scenario list indicates that the attack path number which is the number of attack paths through which the attack on the verification environment 40 has succeeded is “1”, and the attack scenario number which is the number of attack scenarios in which the attack has succeeded is “3”. In this case, for example, the risk calculation unit 20D calculates, as the risk value, “3” that is a result of multiplication of the attack path number and the attack scenario number.

The display control unit 20A displays the verification result screen 60A, the attack path screen 60B, and the selection screen 60C including the risk value calculated by the risk calculation unit 20D on the display unit 12A.

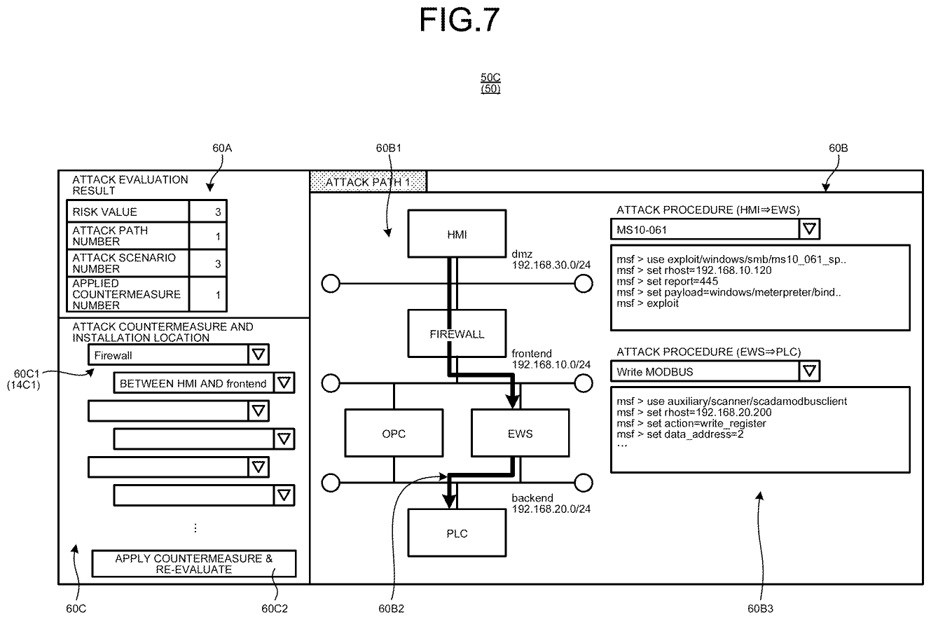

FIG. 7 is a schematic diagram of an example of a display screen 50C. The display screen 50C is an example of the display screen 50. FIG. 7 illustrates, as an example, the display screen 50C including the verification result screen 60A and the attack path screen 60B of the verification environment 40 in which the attack countermeasure indicated by the attack countermeasure information 14C1 including the attack countermeasure name “Firewall” and the installation location “between HMI and frontend” is applied.

As illustrated in FIG. 7, the verification result screen 60A displays the risk value indicating the evaluation result of the attack countermeasure applied to the verification environment 40, the applied countermeasure number which is the number of attack countermeasures applied to the verification environment 40, the attack path number which is the number of attack paths through which the attack on the verification environment 40 has succeeded, and the attack scenario number which is the number of attack scenarios in which the attack has succeeded.

The user can easily confirm the evaluation result of the attack countermeasure applied to the verification environment 40 by viewing the verification result screen 60A.

In addition, as illustrated in FIG. 7, the attack path screen 60B includes the configuration image 60B1 of the verification environment 40, the successful attack path image 60B2, and the attack procedure 60B3.

The user can easily confirm the configuration of the verification environment 40 in which the attack countermeasure is applied, the successful attack path, and the attack procedure along the attack path through which the attack has succeeded by viewing the attack path screen 60B.

In addition, the user can easily confirm the evaluation result of the attack countermeasure applied to the verification environment 40 and the attack scenario in which the attack on the verification environment 40 has succeeded by viewing the verification result screen 60A and the attack path screen 60B.

Furthermore, similarly to the above, the display control unit 20A further displays the selection screen 60C (see FIG. 7). Therefore, the user selects and inputs new attack countermeasure information 14C1 at the selection field 60C1 via the selection screen 60C and operates the execution button 60C2, so that it is possible to easily confirm the evaluation result of another attack countermeasure applied to the verification environment 40.

Furthermore, the user can easily instruct the information processing apparatus 10 to perform additional verification in a case where another attack countermeasure is applied based on the evaluation result of the previously applied attack countermeasure by operating the selection screen 60C while viewing the verification result screen 60A and the attack path screen 60B.

Next, an example of a flow of the information processing performed by the information processing apparatus 10 according to the present embodiment will be described.

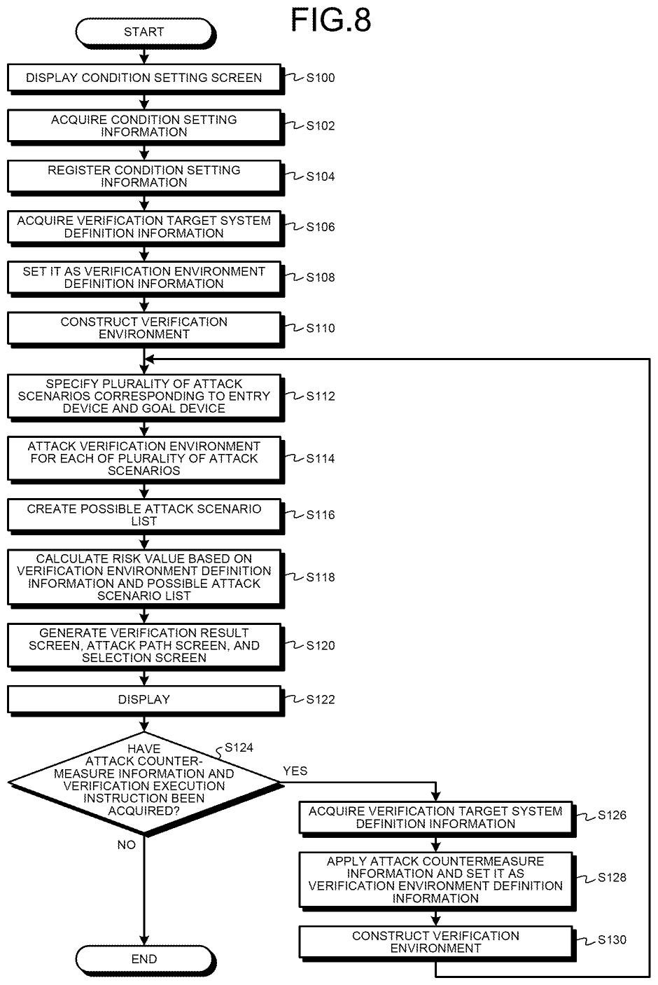

FIG. 8 is a flowchart illustrating an example of a flow of the information processing performed by the information processing apparatus 10 according to the present embodiment.

The display control unit 20A displays the condition setting screen 50A on the display unit 12A (Step S100). With the processing of Step S100, for example, the display unit 12A displays the condition setting screen 50A illustrated in FIG. 4A.

The user operates the input unit 12B while viewing the condition setting screen 50A displayed on the display unit 12A to select and input a desired entry device and a desired goal device in the condition input field 50A1. The acquisition unit 20B acquires the input condition setting information by these operations performed by the user (Step S102).

The management unit 20E registers, in the condition setting DB 14D, information indicating the entry device and the goal device included in the condition setting information acquired in Step S102 (Step S104). With the processing of Step S104, the management unit 20E registers, in the condition setting DB 14D, for example, the information indicating the entry device and the goal device included in the condition setting information input by the user (see FIG. 3E).

The setting unit 20F acquires the verification target system definition information 14A stored in the storage unit 14 (Step S106) and sets it as the verification environment definition information 14E (Step S108). At this time, as described above, the setting unit 20F sets “false” indicating that the device is not a device installed for attack countermeasures in the field of the attack countermeasure device corresponding to each device ID set in the verification environment definition information 14E.

The construction unit 20G constructs the verification environment 40 by using the verification environment definition information 14E set in Step S108 (Step S110).

Next, the verification unit 20H specifies the entry device and the goal device indicated by the condition setting information registered in the condition setting DB 14D in Step S104. Then, the verification unit 20H specifies a plurality of attack scenarios corresponding to a combination of the specified entry device and the specified goal device from the attack scenario DB 14B (Step S112).

Then, the verification unit 20H performs an attack having an attack content represented by an attack scenario on the verification environment 40 constructed by the construction unit 20G for each of the plurality of attack scenarios specified in Step S112 (Step S114). Then, in a case where the attack has reached the goal device, the verification unit 20H holds the attack scenario as an attack scenario in which the attack has succeeded.

Then, once the execution of all of the plurality of specified attack scenarios is completed, the verification unit 20H creates the possible attack scenario list that is a list of attack scenarios in which the attack has succeeded (Step S116).

The risk calculation unit 20D calculates the risk value representing the evaluation result of the attack countermeasure applied to the verification environment 40 based on the possible attack scenario list generated in Step S116 (Step S118). The risk calculation unit 20D acquires the possible attack scenario list from the verification unit 20H via the management unit 20E, and acquires the verification environment definition information 14E from the management unit 20E. Then, the risk calculation unit 20D calculates the risk value representing the evaluation result of the attack countermeasure applied to the verification environment 40 by using the acquired possible attack scenario list and verification environment definition information 14E.

The display control unit 20A generates the verification result screen 60A including the risk value calculated in Step S118, the attack path screen 60B, and the selection screen 60C (Step S120).

Then, the display control unit 20A displays the display screen 50 including the verification result screen 60A, the attack path screen 60B, and the selection screen 60C generated in Step S120 on the display unit 12A (Step S122). With the processing of Step S122, for example, the display unit 12A displays the display screen 50 of FIG. 4B, FIG. 7, or the like.

The acquisition unit 20B determines whether or not the attack countermeasure information 14C1 including the name of the attack countermeasure applied to the verification target system 30 and the installation location of the attack countermeasure having the attack countermeasure name and the verification execution instruction have been acquired from the UI unit 12 (Step S124). The user can operate the input unit 12B to select and input a desired attack countermeasure name and a desired installation location in the selection field 60C1 of the selection screen 60C, and operate the execution button 60C2, thereby selecting desired attack countermeasure information 14C1. Once this selection operation is performed, the acquisition unit 20B acquires the attack countermeasure information 14C1 and the verification execution instruction from the UI unit 12.

In a case where an affirmative determination is made in Step S124 (Step S124: Yes), the processing proceeds to Step S126. In Step S126, the setting unit 20F clears all pieces of information currently set in the verification environment definition information 14E and acquires the verification target system definition information 14A from the storage unit 14 (Step S126).

Then, the setting unit 20F applies the attack countermeasure indicated by the attack countermeasure information 14C1 acquired in Step S124 to the verification target system definition information 14A acquired in Step S126 and sets it as the verification environment definition information 14E (Step S128). For example, the verification environment definition information 14E illustrated in FIGS. 5A and 5B is set by the processing of Step S128.

The construction unit 20G constructs the verification environment 40 by using the verification environment definition information 14E set in Step S128 (Step S130). Then, the processing proceeds to Step 112 described above.

On the other hand, in a case where a negative determination is made in Step S124 (Step S124: No), this routine ends.

As described above, the information processing apparatus 10 according to the present embodiment includes the verification execution unit 20C and the risk calculation unit 20D. The verification execution unit 20C attacks the verification environment 40, in which at least one of attack countermeasures indicated by the attack countermeasure information 14C1 is applied to the verification target system 30, by using each of a plurality of attack scenarios, and creates a possible attack scenario list that is a list of attack scenarios in which the attack has succeeded. The risk calculation unit 20D calculates a risk value representing an evaluation result of an attack countermeasure applied to the verification environment 40 based on the possible attack scenario list.

Here, in the related art, evaluation of an attack countermeasure is performed for each individual device or each individual attack, and evaluation of an attack countermeasure against a plurality of attacks on a verification target system has not been performed.

On the other hand, the information processing apparatus 10 according to the present embodiment attacks the verification environment 40 in which the attack countermeasure is applied, by using each of the plurality of attack scenarios. Then, the information processing apparatus 10 according to the present embodiment calculates the risk value representing the evaluation result of the attack countermeasure applied to the verification environment 40 based on the possible attack scenario list that is a list of attack scenarios in which the attack has succeeded.

As described above, the information processing apparatus 10 according to the present embodiment attacks the verification environment 40 to which the attack countermeasure is applied by using each of the plurality of attack scenarios, thereby calculating the risk value representing the evaluation result of the attack countermeasure applied to the verification environment 40.

Therefore, the information processing apparatus 10 according to the present embodiment can evaluate the attack countermeasure against a plurality of attacks on the verification target system 30.

In addition, since the information processing apparatus 10 according to the present embodiment calculates the risk value representing the evaluation result of the attack countermeasure against a plurality of attacks, it is possible to provide information with which the effect of the attack countermeasure applied to the verification target system 30 can be easily grasped.

For example, it is assumed that the user selects “Firewall” as the attack countermeasure at the first verification and selects “OT-IDS” as the attack countermeasure at the second verification. In addition, it is assumed that the risk values calculated for the verification environment 40 in which these attack countermeasures are applied are “3” and “14”, respectively. In this case, the user can determine, by confirming these risk values, that applying “Firewall” as the attack countermeasure is more effective as compared with applying “OT-IDS” as the attack countermeasure.

In order to quickly deal with a cyberattack on the verification target system 30, it is required to comprehensively deal with various attacks in a short time and at low cost. Since the information processing apparatus 10 according to the present embodiment can provide the evaluation result of the attack countermeasure against a plurality of attacks, it is possible to provide information with which an attack countermeasure that can comprehensively cope with a plurality of attacks can be easily selected.

### First Modified Example

In the above-described embodiment, a form in which the display control unit 20A displays the display screen 50 including the condition input field 50A1 for receiving the input of one entry device and one goal device on the display unit 12A has been described as an example (see FIG. 4A).

However, the display control unit 20A may display a condition input field for receiving each of a plurality of entry devices and goal devices.

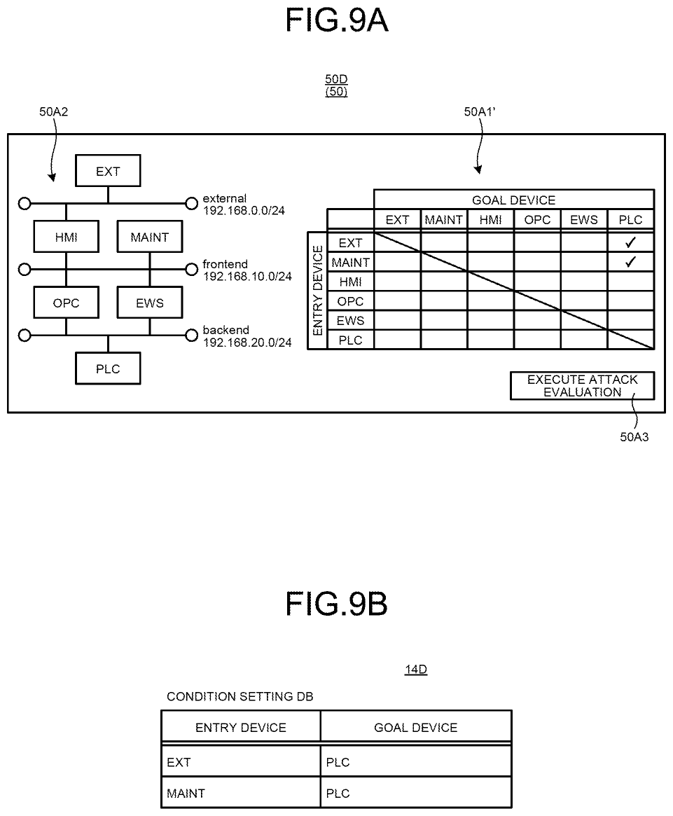

FIG. 9A is a schematic diagram illustrating an example of a condition setting screen 50D according to the present modified example. The condition setting screen 50D is an example of the display screen 50.

As illustrated in FIG. 9A, similarly to the condition setting screen 50A (see FIG. 4A), the condition setting screen 50D is an input screen for receiving the setting of the entry device and the goal device of the attack on the verification target system 30 from the user. For example, similarly to the condition setting screen 50A, the condition setting screen 50D includes a condition input field 50A1′, the configuration image 50A2 of the verification target system 30, and the execution button 50A3.

For example, it is assumed that the verification target system 30 has a configuration represented by the configuration image 50A2 of the verification target system 30 in FIG. 9A. In addition, it is assumed that the storage unit 14 stores in advance the verification target system definition information 14A of the verification target system 30 represented by the configuration image 50A2 illustrated in FIG. 9A.

In this case, for example, the display control unit 20A creates an image representing the configuration of the verification target system 30 indicated by the verification target system definition information 14A stored in the storage unit 14, and displays the image as the configuration image 50A2 of the verification target system 30.

In addition, the display control unit 20A displays each device registered in the verification target system definition information 14A in the condition input field 50A1′ as an option of the entry device and the goal device. In the present modified example, the display control unit 20A displays a plurality of goal devices and a plurality of entry devices in the condition input field 50A1′ in a selectable manner.

Therefore, the user operates the input unit 12B while viewing the condition setting screen 50D displayed on the display unit 12A to select and input a plurality of desired entry devices and a plurality of desired goal devices in the condition input field 50A1′.

A plurality of pieces of condition setting information indicating the entry devices and the goal devices are input through the condition setting screen 50D by these operations performed by the user. Then, once the user operates the execution button 50A3 according to an operation instruction of the input unit 12B, the acquisition unit 20B acquires the plurality of pieces of input condition setting information.

In this case, it is sufficient if the management unit 20E registers the plurality of pieces of condition setting information input via the condition input field 50A1′ in the condition setting DB 14D.

FIG. 9B is a schematic diagram illustrating an example of a data configuration of the condition setting DB 14D stored in the storage unit 14 in the present modified example. As illustrated in FIG. 9B, in the present modified example, the management unit 20E registers a plurality of pieces of condition setting information input by the user in the condition setting DB 14D.

For example, as illustrated in FIG. 9A, it is assumed that the user selects and inputs condition setting information including the entry device “EXT (an external connection device connected to the Internet)” and the goal device “PLC” and condition setting information including the entry device “MAINT (maintenance device)” and the goal device “PLC”. In this case, as illustrated in FIG. 9B, the management unit 20E sets the plurality of pieces of condition setting information in the condition setting DB 14D.

In this case, it is sufficient if the control unit 20 attacks the verification environment 40 by using each of a plurality of attack scenarios for each of a plurality of condition settings set in the condition setting DB 14D every time the construction unit 20G constructs the new verification environment 40, similarly to the above-described embodiment. Then, similarly to the above-described embodiment, it is sufficient if the control unit 20 creates the possible attack scenario list that is a list of attack scenarios in which the attack has succeeded, and the risk calculation unit 20D may calculate the risk value based on the possible attack scenario.

As described above, in the present modified example, the information processing apparatus 10 receives a plurality of pieces of condition setting information, and attacks each verification environment 40 to which the attack countermeasure is applied by using each of a plurality of attack scenarios, for each of the plurality of pieces of condition setting information. Therefore, the information processing apparatus 10 according to the present modified example can perform an attack using various combinations of devices as the entry device and the goal device on the verification environment 40, and calculate the risk value for each combination.

Therefore, in addition to achieving the effects of the above-described embodiment, the information processing apparatus 10 according to the present modified example can provide the risk value indicating the evaluation result for each of the combinations of the plurality of types of entry devices and the goal device, for the verification environment 40 to which the attack countermeasure is applied.

Therefore, for example, the information processing apparatus 10 according to the present modified example can simultaneously evaluate attack resistance against both an attack entering from an external device installed on the Internet and an attack entering from an internal maintenance device.

Furthermore, in the present modified example, the user can select an optimal attack countermeasure against a plurality of attacks with different combinations of the entry devices and the goal devices by confirming the risk value for each of the combinations of the plurality of types of entry devices and the goal device.

### Second Modified Example

In the above-described embodiment, a form in which the display control unit 20A displays the evaluation result of the attack countermeasure applied to one constructed verification environment 40 on the verification result screen 60A has been described as an example (see FIG. 7). However, the display control unit 20A may store and display a verification execution history.

In this case, it is sufficient if the control unit 20 sequentially stores verification results in the storage unit 14 as a history each time the new verification environment 40 is constructed and verified.

Then, the display control unit 20A of the control unit 20 only needs to display a verification result of each of a plurality of verified verification environments 40 on the verification result screen and display an attack path screen of each of the plurality of verification environments 40.

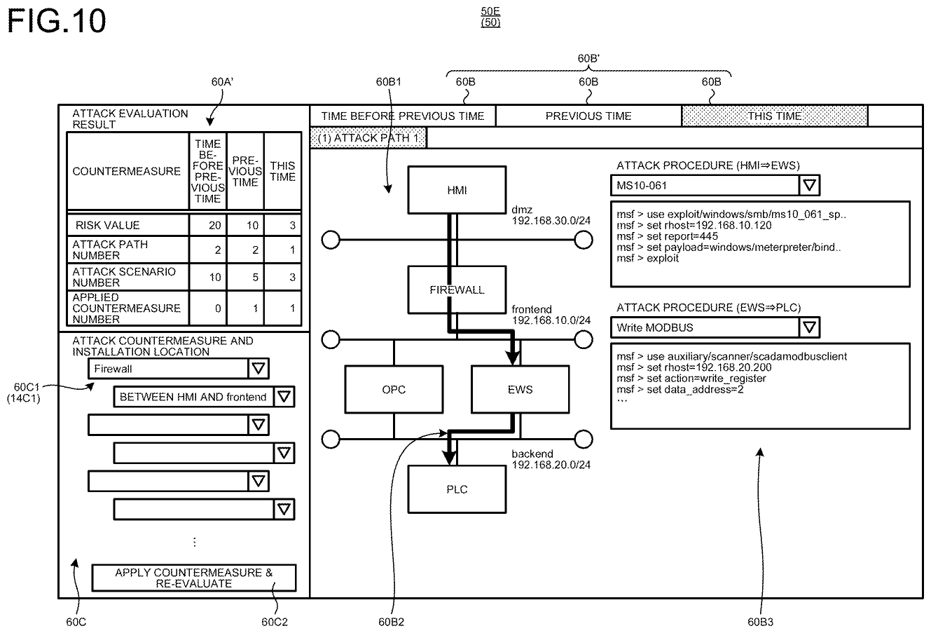

FIG. 10 is a schematic diagram of an example of a display screen 50E according to the present modified example. The display screen 50E is an example of the display screen 50. The display screen 50E includes a verification result screen 60A′, an attack path screen 60B′, and the selection screen 60C.

For example, the display control unit 20A displays the risk value, the attack path number, and the attack scenario number for each of the plurality of verification environments 40 on the verification result screen 60A′ for each of the plurality of verification environments 40.

In addition, the display control unit 20A displays the attack path screen 60B′ including the attack path screen 60B corresponding to each of the plurality of verification environments 40 by using the possible attack scenario list for each of the plurality of verification environments 40. FIG. 10 illustrates an example in which the display of the attack path screen 60B for each of the plurality of verification environments 40 is switched by the user operating a tab.

As described above, the control unit 20 according to the present modified example sequentially stores the verification results in the storage unit 14 as a history each time the new verification environment 40 is constructed and verified. Then, the display control unit 20A displays, based on the history of the verification results, the verification result screen 60A′ including the verification result for each of the plurality of verification environments 40 constructed in the past, and the attack path screen 60B′ including the attack path screen 60B corresponding to each of the plurality of verification environments 40.

Therefore, in addition to achieving the effects of the above-described embodiment, the information processing apparatus 10 according to the present modified example can provide the evaluation result of the attack countermeasure for the verification environment 40 to which no attack countermeasure is applied and each of the plurality of verification environments 40 to which different attack countermeasures are applied in an easily comparable manner. In addition, the user can easily confirm a difference between the verification results for the plurality of verification environments 40 to which different attack countermeasures are applied by viewing the display screen 50E. Furthermore, the user can easily select an optimal attack countermeasure by viewing the display screen 50E.

### Second Embodiment

In the above-described embodiment, a form in which one piece of attack countermeasure information 14C1 is selected via the selection screen 60C has been described as an example.

In the present embodiment, a form in which a plurality of pieces of attack countermeasure information 14C1 are selected at a time by the user operating the execution button once, and a plurality of attack countermeasures are simultaneously evaluated, will be described as an example. In the present embodiment, functions similar to those in the above-described embodiment are denoted by the same reference signs, and a detailed description thereof will be omitted.

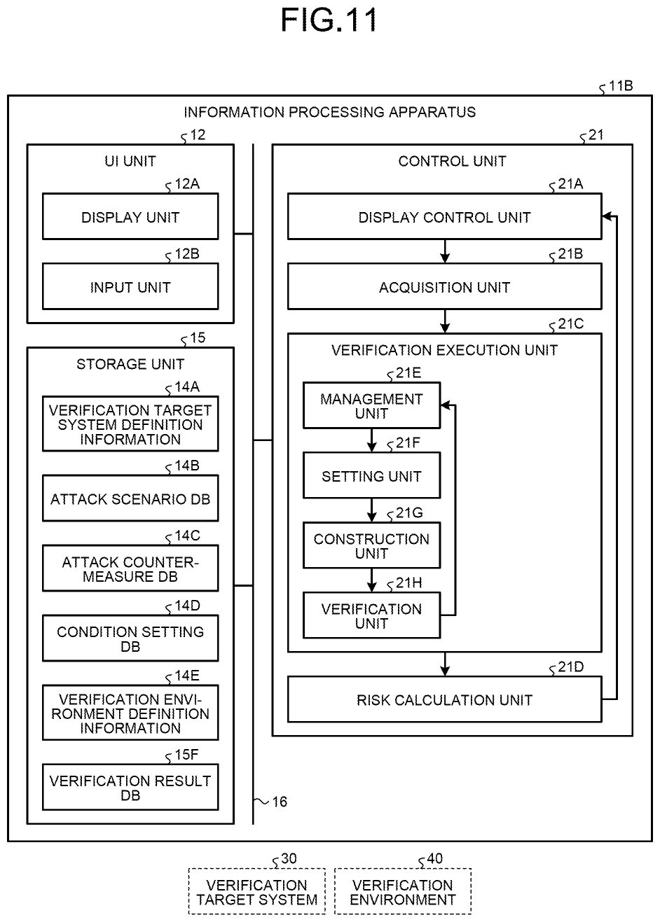

FIG. 11 is a schematic diagram of an example of an information processing apparatus 11B according to the present embodiment.

The information processing apparatus 11B includes a UI unit 12, a storage unit 15, and a control unit 21. The UI unit 12, the storage unit 15, and the control unit 21 are communicably connected via a bus 16 or the like. The UI unit 12 is similar to that of the above-described embodiment.

The storage unit 15 stores various types of information. The storage unit 15 further stores a verification result DB 15F in addition to the information stored in the storage unit 14 of the above-described embodiment.

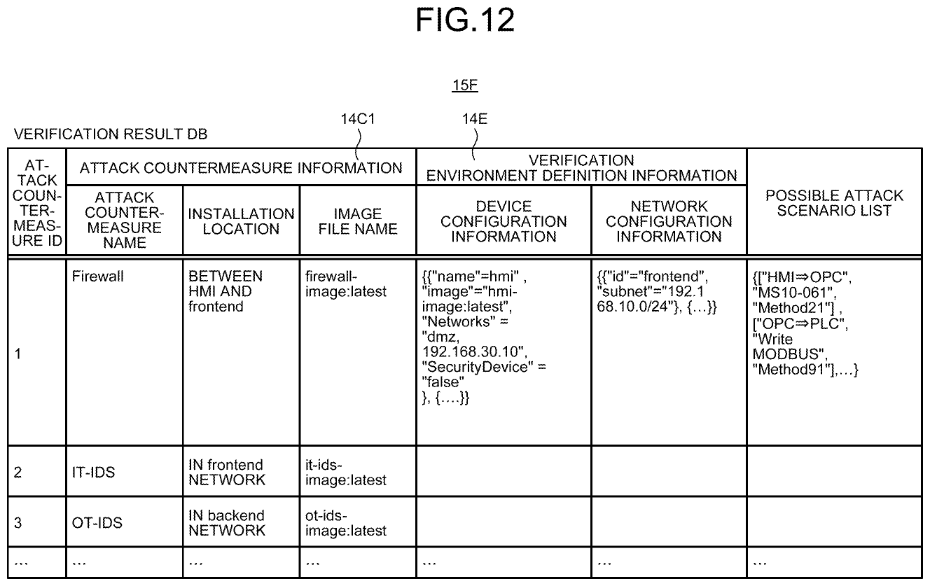

FIG. 12 is a schematic diagram illustrating an example of a data configuration of the verification result DB 15F. The verification result DB 15F is a database for managing information regarding a verification result of a verification environment 40 to which an attack countermeasure indicated by each of the plurality of pieces of attack countermeasure information 14C1 is applied.

Specifically, the verification result DB 15F is a database in which an attack countermeasure ID, the attack countermeasure information 14C1, verification environment definition information 14E, and a possible attack scenario list are associated with each other. The data format of the verification result DB 15F is not limited to the database.

The attack countermeasure ID is identification information of an attack countermeasure indicated by the corresponding attack countermeasure information 14C1.

The verification result DB 15F is updated by processing performed by the control unit 21 described later.

Returning to FIG. 11, the description will be continued. The control unit 21 performs information processing in the information processing apparatus 11B. The control unit 21 includes a display control unit 21A, an acquisition unit 21B, a verification execution unit 21C, and a risk calculation unit 21D. The verification execution unit 21C includes a management unit 21E, a setting unit 21F, a construction unit 21G, and a verification unit 21H.

The display control unit 21A, the acquisition unit 21B, the verification execution unit 21C, the risk calculation unit 21D, the management unit 21E, the setting unit 21F, the construction unit 21G, and the verification unit 21H are implemented by, for example, one or more processors. Furthermore, at least one of the above-described units may be provided in an external information processing apparatus connected to the information processing apparatus 11B via a network.

The display control unit 21A controls display of various types of information on a display unit 12A, similarly to the display control unit 20A. Similarly to the acquisition unit 20B, the acquisition unit 21B acquires various types of information input by the user operating an input unit 12B.

Similarly to the verification execution unit 20C, the verification execution unit 21C constructs the verification environment 40 in which the attack countermeasure indicated by the attack countermeasure information 14C1 is applied to the verification target system 30, attacks the verification environment 40 by using each of a plurality of attack scenarios, and creates the possible attack scenario list that is a list of attack scenarios in which the attack has succeeded.

In the present embodiment, for each of the plurality of pieces of attack countermeasure information 14C1, the verification execution unit 21C attacks a plurality of verification environments 40 to which the attack countermeasures indicated by the pieces of attack countermeasure information 14C1 are applied, and creates the possible attack scenario list for each of the plurality of verification environments 40. Then, the risk calculation unit 21D calculates a risk value for each attack countermeasure based on the possible attack scenario list.

Note that, in a case where the verification target system 30 to which no attack countermeasure is applied is set as the verification environment 40, the verification execution unit 21C performs processing similar to that of the verification execution unit 20C of the above-described embodiment. Therefore, a case where the verification target system 30 to which the attack countermeasure is applied is set as the verification environment 40 will be described in detail below.

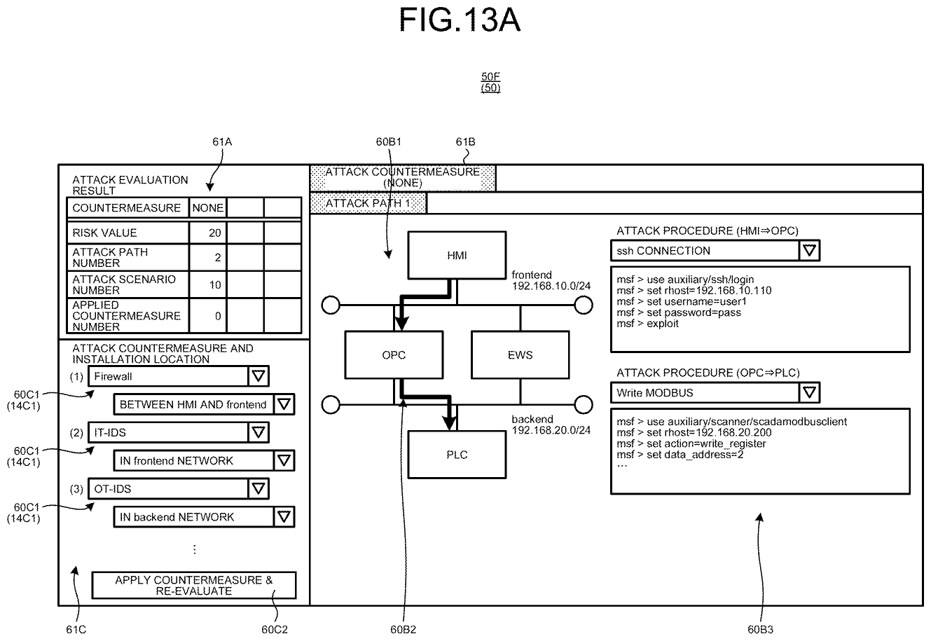

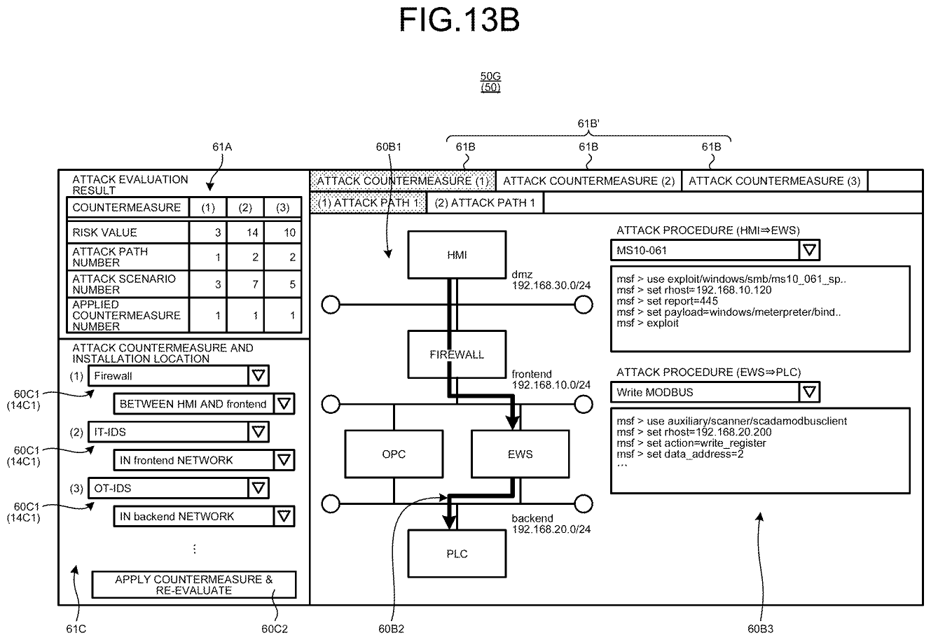

FIG. 13A is a schematic diagram of an example of a display screen 50F. The display screen 50F is an example of the display screen 50.

The display screen 50F includes a verification result screen 61A, an attack path screen 61B, and a selection screen 61C. FIG. 13A illustrates an example of a case where the verification result screen 61A and the attack path screen 61B showing a verification result of the verification environment 40 to which no attack countermeasure is applied are displayed.

Similarly to the verification result screen 60A, the verification result screen 61A includes the risk value and at least one of the applied countermeasure number, the attack path number, or the attack scenario number.

In the present embodiment, the display control unit 21A displays the verification result screen 61A including the risk value for each of the plurality of verification environments 40, that is, the risk value for each attack countermeasure applied to each of the plurality of verification environments 40. Specifically, the display control unit 21A displays the risk value, the applied countermeasure number, the attack path number, and the attack scenario number on the verification result screen 61A for each attack countermeasure.

In addition, the display control unit 21A displays the attack path screen 61B for each attack countermeasure. The attack path screen 61B is similar to the attack path screen 60B of the above-described embodiment. That is, the attack path screen 61B includes a configuration image 60B1 of the verification environment 40, a successful attack path image 60B2, and an attack procedure 60B3.

Similarly to the selection screen 60C, the selection screen 61C is a selection screen for selection of the attack countermeasure information 14C1 including the attack countermeasure name of the attack countermeasure and the installation location of the attack countermeasure for the verification target system 30.

In the present embodiment, the display control unit 21A reads a plurality of pieces of attack countermeasure information 14C1 indicating a correspondence between the attack countermeasure name and the installation location from an attack countermeasure DB 14C (see FIG. 3D). Then, the display control unit 21A displays a pair of the attack countermeasure name and the installation location included in the plurality of pieces of read attack countermeasure information 14C1 in a selection field 60C1 in a selectable manner. FIG. 13A illustrates an example of a case where the attack countermeasure information 14C1 of each of three attack countermeasures including attack countermeasure (1) having the attack countermeasure name “Firewall” and the installation location “between HMI and frontend”, attack countermeasure (2) having the attack countermeasure name “IT-IDS” and the installation location “in frontend network”, and attack countermeasure (3) having the attack countermeasure name “OT-IDS” and the installation location “in backend network” is displayed as an option.

That is, in the present embodiment, the display control unit 21A displays a plurality of piece of attack countermeasure information 14C1 each including a pair of one attack countermeasure name and one installation location on the selection screen 60C in a selectable manner.

The user operates the input unit 12B while viewing the selection screen 61C to select the name of the attack countermeasure to be applied to the verification target system 30 and the installation location of the attack countermeasure having the attack countermeasure name. With this selection processing, the user inputs the attack countermeasure information 14C1 of a plurality of desired attack countermeasures.

Then, it is assumed that the user further operates an execution button 60C2 by operating the input unit 12B. The execution button 60C2 is a button image for instructing execution of verification as in the above-described embodiment. Once the user operates the execution button 60C2 by operating the input unit 12B, the acquisition unit 21B acquires the plurality of pieces of input attack countermeasure information 14C1 and the verification execution instruction.

That is, in the present embodiment, the information processing apparatus 11B receives the verification execution instruction for the verification environment 40 in which each of the attack countermeasures indicated by the plurality of pieces of selected attack countermeasure information 14C1 is applied by the user operating the execution button 60C2 once. As a result, the user can instruct execution of verification for a plurality of attack countermeasures by inputting a plurality of pieces of desired attack countermeasure information 14C1 that are desired to be applied to the verification target system 30 and evaluated, and operating the execution button 60C2 once.

Returning to FIG. 11, the description will be continued. Once the acquisition unit 21B acquires the plurality of pieces of attack countermeasure information 14C1 and the verification execution instruction from the input unit 12B, the verification execution unit 21C constructs the verification environment 40 in which the attack countermeasure indicated by each of the plurality of pieces of input attack countermeasure information 14C1 is applied. Then, the verification execution unit 21C performs the verification processing for each of the plurality of constructed verification environments 40 in a manner similar to that in the above-described embodiment.

Specifically, the verification execution unit 21C of the control unit 21 constructs the verification environment 40 in which the attack countermeasure indicated by the attack countermeasure information 14C1 is applied for each of the plurality of pieces of attack countermeasure information 14C1 selected via the selection screen 61C, attacks each of the plurality of constructed verification environments 40, and creates the possible attack scenario list for each of the plurality of verification environments 40. Then, the risk calculation unit 21D calculates the risk value for each of the verification environments 40, that is, the risk value for each attack countermeasure based on the attack scenario list, and it is sufficient if the risk calculation unit 21D calculates the risk value based on the attack scenario list similarly to the risk calculation unit 20D.

The display control unit 21A displays the verification result screen 61A including the risk value calculated for each of the plurality of attack countermeasures by the risk calculation unit 21D.

FIG. 13B is a schematic diagram of an example of a display screen 50G. The display screen 50G is an example of the display screen 50. The display screen 50G includes the verification result screen 61A, an attack path screen 60B′ including the attack path screen 60B corresponding to each of the plurality of verification environments 40, and the selection screen 61C.

As described above, in the present embodiment, the display control unit 21A displays the verification result screen 61A including the risk value for each attack countermeasure. Therefore, the verification result screen 61A displays the verification result for each of the plurality of attack countermeasures.

FIG. 13B illustrates an example of a case where the verification result for each of the three attack countermeasures (1) to (3) input via the selection screen 60C of the display screen 50F illustrated in FIG. 13A is displayed. As in this example, the verification result screen 61A displays the verification result for each of the plurality of attack countermeasures.

In addition, the display control unit 21A displays the attack path screen 61B for each of the plurality of verification environments 40, that is, for each attack countermeasure applied to each of the plurality of verification environments 40. Therefore, the display screen 50G displays an attack path screen 61B′ including the attack path screen 61B for each of the plurality of attack countermeasures.

FIG. 13B illustrates an example of a case where a plurality of attack path screens 61B corresponding to the three attack countermeasures (1) to (3) input via the selection screen 60C of the display screen 50F illustrated in FIG. 13A are displayed. In addition, FIG. 13B illustrates an example in which the display of the attack path screen 60B for each of the plurality of verification environments 40 is switched by operating a tab.

Therefore, the user can easily confirm a difference between the verification results for the plurality of attack countermeasures by viewing the display screen 50G.

Furthermore, the user can easily select an optimal attack countermeasure by viewing the display screen 50G.

Similarly to the above, the display control unit 21A displays the selection screen 61C. Therefore, the user selects and inputs a plurality of pieces of new attack countermeasure information 14C1 via the selection screen 61C and operates the execution button 60C2, so that it is possible to easily confirm the verification result for each of a plurality of other attack countermeasures.

Next, an example of a flow of the information processing performed by the information processing apparatus 10 according to the present embodiment will be described.

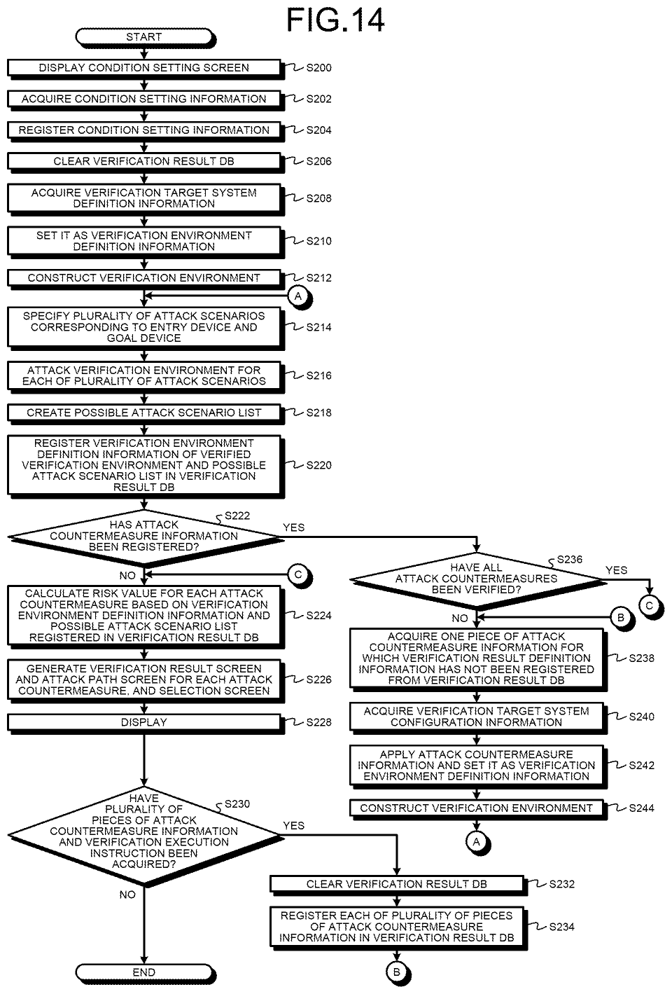

FIG. 14 is a flowchart illustrating an example of a flow of information processing performed by the information processing apparatus 11B according to the present embodiment.

The control unit 21 performs processing of Steps S200 to S204 in a similar manner to Steps S100 to S104 (see FIG. 8) of the above-described embodiment.

Specifically, the display control unit 21A displays a condition setting screen 50A on the display unit 12A (Step S200). The user operates the input unit 12B while viewing the condition setting screen 50A displayed on the display unit 12A to select and input a desired entry device and a desired goal device in the condition input field 50A1. The acquisition unit 21B acquires input condition setting information by these operations performed by the user (Step S202). The management unit 21E registers, in a condition setting DB 14D, information indicating the entry device and the goal device included in the condition setting information acquired in Step S202 (Step S204).

Next, the management unit 21E clears all pieces of information registered in the verification result DB 15F and registers information “NULL” indicating attack countermeasure information “none” in the field of the attack countermeasure information in the verification result DB 15F (Step S206) (see also FIG. 12).

Then, the control unit 21 performs the processing of Steps S208 to S218 in a similar manner to Steps S106 to S116 of the above-described embodiment.

Specifically, the setting unit 21F acquires verification target system definition information 14A stored in the storage unit 15 (Step S208) and sets it as the verification environment definition information 14E (Step S210). The construction unit 21G constructs the verification environment 40 by using the verification environment definition information 14E set in Step S210 (Step S212). The verification unit 21H specifies the entry device and the goal device indicated by the condition setting information registered in the condition setting DB 14D in Step S204. Then, the verification unit 21H specifies a plurality of attack scenarios corresponding to a combination of the specified entry device and the specified goal device from an attack scenario DB 14B (Step S214).

Then, the verification unit 21H performs an attack having an attack content represented by an attack scenario on the verification environment 40 constructed by the construction unit 21G for each of the plurality of attack scenarios specified in Step S214 (Step S214). Then, in a case where the attack has reached the goal device, the verification unit 21H holds the attack scenario as an attack scenario in which the attack has succeeded. Then, once the execution of all of the plurality of specified attack scenarios is completed, the verification unit 21H creates the possible attack scenario list that is a list of attack scenarios in which the attack has succeeded (Step S218).

The management unit 21E registers the possible attack scenario list created in Step S218 and the verification environment definition information 14E of the verification environment 40 verified in Step S216 in the verification result DB 15F in association with each other (Step S220). At this time, the management unit 21E creates an attack countermeasure ID and registers the attack countermeasure ID in the verification result DB 15F in association with them.

Next, the management unit 21E determines whether or not the attack countermeasure information 14C1 has been registered in association with the verification environment definition information 14E registered in the verification result DB 15F in Step S220 (Step S222). That is, the management unit 21E determines whether or not the verification environment 40 indicated by the verification environment definition information 14E registered in the verification result DB 15F is the verification environment 40 to which the attack countermeasure is applied. Specifically, in a case where the information “NULL” indicating the attack countermeasure information “none” is registered in the field of the attack countermeasure information corresponding to the verification environment definition information 14E registered in the verification result DB 15F in Step S220, the management unit 21E determines that the verification environment 40 indicated by the verification environment definition information 14E registered in the verification result DB 15F is not the verification environment 40 to which the attack countermeasure is applied.

In a case where it is determined that the verification environment 40 indicated by the verification environment definition information 14E registered in the verification result DB 15F is not the verification environment to which the attack countermeasure is applied (Step S222: No), the processing proceeds to Step S224.

In Step S224, the risk calculation unit 21D calculates the risk value for each attack countermeasure represented by the attack countermeasure information 14C1 registered in the verification result DB 15F by using the verification environment definition information 14E and the possible attack scenario list corresponding to each of all the attack countermeasure IDs registered in the verification result DB 15F (Step S224).

It is sufficient if the risk calculation unit 21D acquires the verification environment definition information 14E and the attackable list registered in the verification result DB 15F from the verification result DB 15F via the management unit 21E and uses them for calculation of the risk value. In addition, it is sufficient if the risk calculation unit 21D calculates the risk value similarly to the risk calculation unit 20D of the above-described embodiment. With the processing of Step S224, the risk calculation unit 21D calculates the risk value for each attack countermeasure. Note that, in a case of the attack countermeasure identified with the attack countermeasure ID for which the information “NULL” indicating the attack countermeasure information “none” is registered in the verification result DB 15F, the risk calculation unit 21D calculates the risk value for the attack countermeasure “none”.

The display control unit 21A generates the verification result screen 60A including the risk value calculated in Step S224 and the attack path screen 60B for each attack countermeasure (Step S226). In addition, the display control unit 21A generates the selection screen 61C. That is, the display control unit 21A generates the verification result screen 60A and the attack path screen 60B for each attack countermeasure, and the selection screen 61C.

Then, the display control unit 21A displays the display screen 50 including the verification result screen 61A and the attack path screen 61B generated for each attack countermeasure in Step S226, and the selection screen 61C on the display unit 12A (Step S228). With the processing of Step S228, for example, the display unit 12A displays the display screen 50 of FIG. 13A, FIG. 13B, or the like.

The acquisition unit 21B determines whether or not a plurality of pieces of attack countermeasure information 14C1 and the verification execution instruction have been acquired from the UI unit 12 (Step S230). The user selects the plurality of pieces of attack countermeasure information 14C1 displayed in each of a plurality of selection fields 60C1 of the selection screen 61C by operating the input unit 12B, and operates the execution button 60C2. By performing these operations, the acquisition unit 21B acquires the plurality of pieces of selected attack countermeasure information 14C1 and the verification execution instruction from the UI unit 12.

In a case where a negative determination is made in Step S230 (Step S230: No), this routine ends. In a case where an affirmative determination is made in Step S230 (Step S230: Yes), the processing proceeds to Step S232. In Step 232, the management unit 21E clears all pieces of information registered in the verification result DB 15F (Step S232). Then, the management unit 21E registers each of the plurality of pieces of attack countermeasure information 14C1 input via the selection screen 61C in Step S230 in the field of the attack countermeasure information in the verification result DB 15F (Step S234). Then, the processing proceeds to Step S238 described later.

On the other hand, in a case where an affirmative determination is made in Step S222 (Step S222: Yes), the processing proceeds to Step S236. The case where an affirmative determination is made in Step S222 is a case where the attack countermeasure information 14C1 is registered in association with the verification environment definition information 14E registered in the verification result DB 15F in Step S220. That is, in a case where the verification environment 40 indicated by the verification environment definition information 14E registered in the verification result DB 15F in Step S220 is the verification environment 40 to which the attack countermeasure is applied, the management unit 21E makes an affirmative determination in Step S222.

In Step S236, the management unit 21E determines whether or not the attack countermeasures indicated by all pieces of attack countermeasure information 14C1 registered in the verification result DB 15F have been verified (Step S236). The management unit 21E determines whether or not the verification environment definition information 14E has been registered in association with all pieces of attack countermeasure information 14C1 registered in the verification result DB 15F, thereby making the determination in Step S236. In a case where an affirmative determination is made in Step S236 (Step S236: Yes), the processing proceeds to Step S224. In a case where a negative determination is made in Step S236 (Step S236: No), the processing proceeds to Step S238.

In Step S238, the management unit 21E acquires one piece of attack countermeasure information 14C1 for which the verification environment definition information 14E has not been registered from the verification result DB 15F (Step S238). That is, the management unit 21E acquires one piece of attack countermeasure information 14C1 of an unverified attack countermeasure among the plurality of pieces of attack countermeasure information 14C1 registered in the verification result DB 15F.

Then, the management unit 21E clears all pieces of information set in the verification environment definition information 14E. Further, the setting unit 21F acquires the verification target system definition information 14A from the storage unit 15 (Step S240). Then, the setting unit 21F sets the verification environment definition information 14E to which the attack countermeasure indicated by the attack countermeasure information 14C1 acquired in Step S238 is applied, in the verification target system definition information 14A acquired in Step S240 (Step S242). It is sufficient if the setting unit 21F sets the verification environment definition information 14E in which the attack countermeasure is applied, similarly to the setting unit 20F of the above-described embodiment.

With the processing of Step S242, the setting unit 21F sets the verification environment definition information 14E indicating the verification environment 40 in which the attack countermeasure indicated by the unverified attack countermeasure information 14C1 acquired from the verification result DB 15F is applied.

Then, the construction unit 21G constructs the verification environment 40 by using the verification environment definition information 14E set in Step S242 (Step S244). It is sufficient if the construction unit 21G constructs the verification environment 40 similarly to the construction unit 20G of the above-described embodiment. Then, the processing returns to Step S214 described above.

As described above, in the information processing apparatus 11B according to the present embodiment, the verification execution unit 21C constructs the verification environment 40 in which the attack countermeasure indicated by an attack countermeasure information 13C1 is applied for each of the plurality of pieces of attack countermeasure information 14C1, attacks each of the plurality of constructed verification environments 40, and creates the possible attack scenario list for each of the plurality of verification environments 40. The risk calculation unit 21D calculates the risk value for each attack countermeasure based on the possible attack scenario list.

As described above, the information processing apparatus 11B according to the present embodiment constructs the verification environment 40 for each of the plurality of pieces of selected attack countermeasure information 14C1, and calculates the risk value for each of the plurality of verification environments 40.

Therefore, the user can instruct execution of verification of the plurality of verification environments 40 in which the attack countermeasure indicated by each of the plurality of pieces of selected attack countermeasure information 14C1 is applied by operating the execution button 60C2 once.

In addition, in the information processing apparatus 11B according to the present embodiment, a plurality of pieces of attack countermeasure information 14C1 are selected at a time by the user operating the execution button once, and a plurality of attack countermeasures indicated by the plurality of pieces of selected attack countermeasure information 14C1 are simultaneously evaluated.

Therefore, the information processing apparatus 11B according to the present embodiment can efficiently evaluate a plurality of attack countermeasures in addition to achieving the effects of the above-described embodiment.

Furthermore, in the information processing apparatus 11B according to the present embodiment, the display control unit 21A displays the verification result screen 61A showing the verification result for each of the plurality of attack countermeasures and the attack path screen 61B′ including the attack path screen 61B for each of the plurality of attack countermeasures.

Therefore, the user can easily compare and confirm a difference between the verification results for the plurality of attack countermeasures by viewing the display screen 50. Furthermore, the user can easily select an optimal attack countermeasure by viewing the display screen 50.

Note that a form in which the information processing apparatus 11B according to the present embodiment constructs the verification environment 40 for each of the plurality of pieces of selected attack countermeasure information 14C1, and calculates the risk value for each of the plurality of verification environments 40 has been described as an example. However, the information processing apparatus 11B may construct the verification environment 40 for each of one or more combinations of the plurality of pieces of selected attack countermeasure information 14C1. Then, the information processing apparatus 11B may calculate the risk value for each of the plurality of constructed verification environments 40 and perform processing similar to the above.

In this case, the information processing apparatus 11B according to the present embodiment can perform evaluation for each of one or more combinations of attack countermeasures in addition to achieving the effects of the above-described embodiment. Furthermore, the information processing apparatus 11B according to the present embodiment can provide information that enables easy selection of an optimal combination of attack countermeasures.

### Third Embodiment

In the present embodiment, a form in which an information processing apparatus calculates a risk value based on the severity of an attack scenario will be described. Functions similar to those in the above-described embodiment are denoted by the same reference signs, and a detailed description thereof will be omitted.

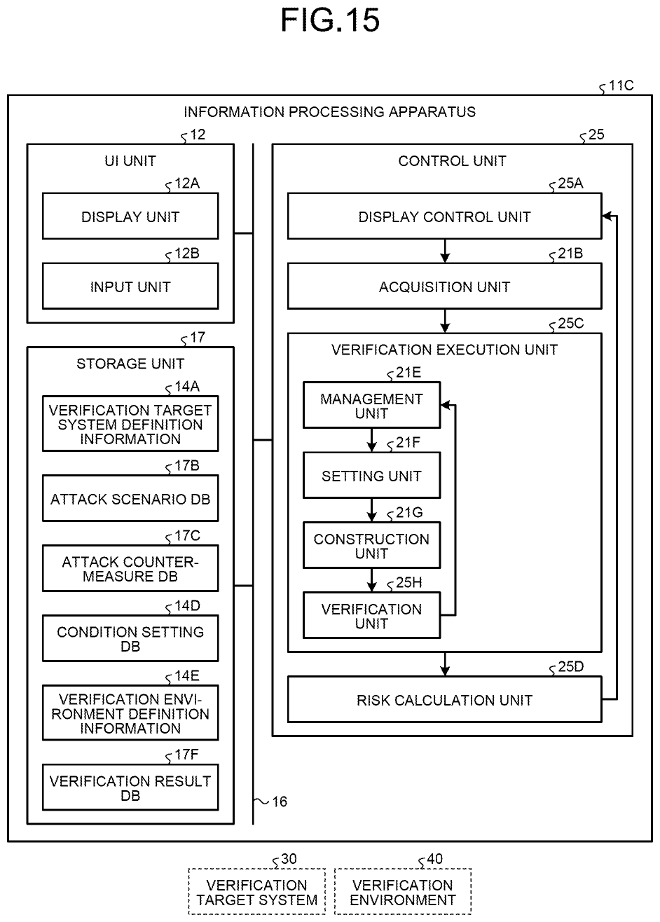

FIG. 15 is a schematic diagram of an example of an information processing apparatus 11C according to the present embodiment.

The information processing apparatus 11C includes a UI unit 12, a storage unit 17, and a control unit 25. The UI unit 12, the storage unit 17, and the control unit 25 are communicably connected via a bus 16 or the like. The UI unit 12 is similar to that of the above-described embodiment.

The storage unit 17 stores various types of information. The storage unit 17 stores an attack scenario DB 17B instead of the attack scenario DB 14B in the second embodiment. In addition, the storage unit 17 stores an attack countermeasure DB 17C instead of the attack countermeasure DB 14C in the second embodiment. In addition, the storage unit 17 stores a verification result DB 17F instead of the verification result DB 15F in the second embodiment.

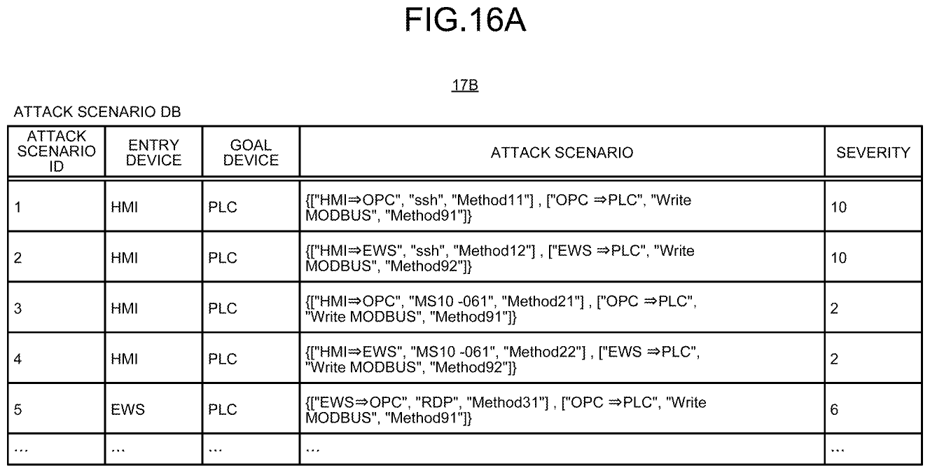

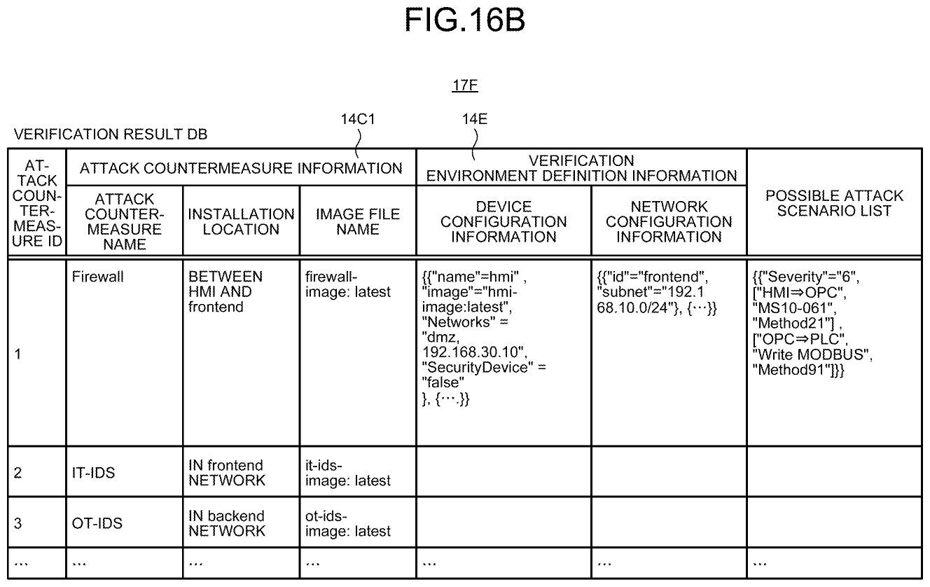

FIG. 16A is a schematic diagram illustrating an example of a data configuration of the attack scenario DB 17B. A plurality of attack scenarios are registered in the attack scenario DB 17B.

The attack scenario DB 17B is, for example, a database in which an attack scenario ID, an entry device, a goal device, an attack scenario, and a severity are associated with each other. That is, the attack scenario DB 17B is a database in which the severity is further registered in the attack scenario DB 14B of the above-described embodiment. The data format of the attack scenario DB 17B is not limited to the database.

The severity is information indicating the severity of an attack scenario. In the attack scenario DB 17B, the severity is registered in advance according to the ease of execution of an attack indicated by the attack scenario, the degree of influence, and the like. Note that the severity may be a value corresponding to a result of multiplication of a common vulnerability scoring system (CVSS) value of the vulnerability indicated by an attack procedure included in the corresponding attack scenario, or the like.

FIG. 16A illustrates, for example, as an attack scenario in which the attach scenario ID is “1”, the entry device is “HMI”, the goal device is “PLC”, and the severity is “10”, for example, an attack scenario in which the attack means “ssh” and the attack method “Method11” are used from the HMI toward the OPC, and then the attack means “Write MODBUS” and the attack method “Method91” are used from the OPC toward the PLC.

FIG. 16B is a schematic diagram illustrating an example of a data configuration of the verification result DB 17F. Similarly to the verification result DB 15F of the above-described embodiment, the verification result DB 17F is a database for managing information regarding a verification result of a verification environment 40 to which an attack countermeasure indicated by each of a plurality of pieces of attack countermeasure information 14C1 is applied. The data format of the verification result DB 17F is not limited to the database.

Specifically, similarly to the verification result DB 15F of the above-described embodiment, the verification result DB 17F is a database in which an attack countermeasure ID, the attack countermeasure information 14C1, verification environment definition information 14E, and a possible attack scenario list are associated with each other. Note that, in the present embodiment, the possible attack scenario list includes the severity for an attack scenario. That is, in the present embodiment, a list of a plurality of severity-added attack scenarios each including an attack scenario in which the attack has succeeded and the severity of the attack scenario, is registered in the verification result DB 17F as the possible attack scenario list.

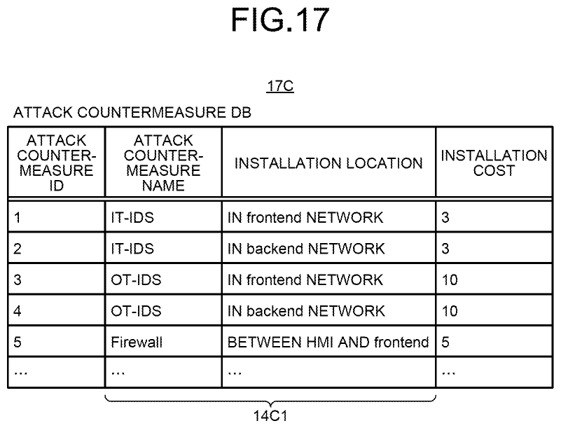

FIG. 17 is a schematic diagram illustrating an example of a data configuration of the attack countermeasure DB 17C. The attack countermeasure DB 17C includes a plurality of pieces of attack countermeasure information 14C1 and an installation cost corresponding to each of the plurality of pieces of attack countermeasure information 14C1. That is, the attack countermeasure DB 17C is a database in which the installation cost is further registered in association with the attack countermeasure DB 14C described in the above-described embodiment.

Specifically, the attack countermeasure DB 17C is, for example, a database in which an attack countermeasure ID, an attack countermeasure name, an installation location, and an installation cost are associated with each other. The data format of the attack countermeasure DB 17C is not limited to the database.

The installation cost is information indicating a cost required for installation and operation of the attack countermeasure indicated by the corresponding attack countermeasure information 14C1.

The attack scenario DB 17B and the attack countermeasure DB 17C are stored in the storage unit 17 in advance. The verification result DB 17F is updated by processing performed by the control unit 25 described later.

Returning to FIG. 15, the description will be continued. The control unit 25 performs information processing in the information processing apparatus 11C. The control unit 25 includes a display control unit 25A, an acquisition unit 21B, a verification execution unit 25C, and a risk calculation unit 25D. The verification execution unit 25C includes a management unit 21E, a setting unit 21F, a construction unit 21G, and a verification unit 25H. The verification execution unit 25C is similar to the verification execution unit 21C of the above-described embodiment except that the verification unit 25H is included instead of the verification unit 21H.

The verification unit 25H of the verification execution unit 25C constructs the verification environment 40 in which the attack countermeasure is applied, and creates the possible attack scenario list that is a list of a plurality of severity-added attack scenarios each including an attack scenario in which the attack has succeeded and the severity of the attack scenario. That is, the verification unit 25H is similar to the verification unit 21H of the above-described embodiment except that the severity-added attack scenario including the severity is used.

The risk calculation unit 25D calculates the risk value based on the attack scenario and the severity included in each of one or more severity-added attack scenarios included in the possible attack scenario list. For example, the risk calculation unit 25D calculates the maximum value of the severity of each of the attack scenarios included in the possible attack scenario list corresponding to the verification environment 40 as the risk value representing the evaluation result of the attack countermeasure applied to the verification environment 40. Note that the risk calculation unit 25D is not limited to a form in which the maximum value of the severity is calculated as the risk value. For example, the risk calculation unit 25D may calculate, as the risk value, an addition value, a multiplication value, an average value, or the like of the severity of each attack scenario included in the possible attack scenario list corresponding to the verification environment 40.

The display control unit 25A displays a display screen 50 on a display unit 12A in a manner similar to that for the display control unit 21A of the above-described embodiment. In the present embodiment, the display control unit 25A displays a verification result screen further including the installation cost indicating a cost required for installation and operation of the attack countermeasure.

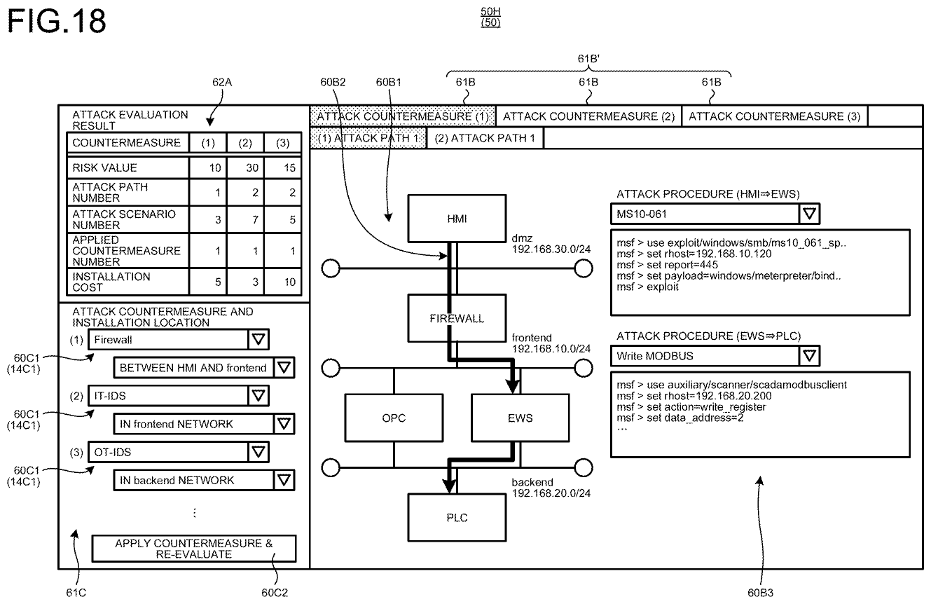

FIG. 18 is a schematic diagram of an example of a display screen 50H. The display screen 50H is an example of the display screen 50. The display screen 50H includes a verification result screen 62A, an attack path screen 60B′ including an attack path screen 60B corresponding to each of a plurality of attack countermeasures, and a selection screen 61C. The attack path screen 60B′ and the selection screen 61C are similar to those in the second embodiment.

As described above, in the present embodiment, the display control unit 21A displays the verification result screen 62A further including the installation cost.

For example, as illustrated in FIG. 18, the verification result screen 62A displays a verification result for each of a plurality of attack countermeasures. In the present embodiment, the verification result includes the installation cost.

The user can compare the effect of the attack countermeasure with the installation cost and select a cost-effective attack countermeasure by viewing the verification result screen 62A including the installation cost.

Next, an example of a flow of the information processing performed by the information processing apparatus 11C according to the present embodiment will be described.

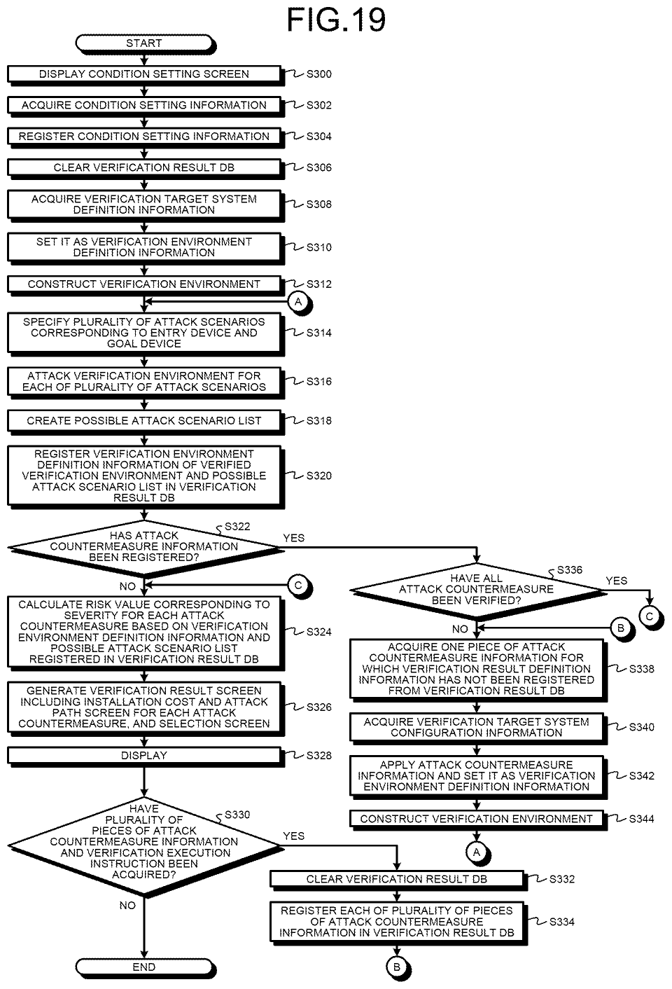

FIG. 19 is a flowchart illustrating an example of a flow of information processing performed by the information processing apparatus 11C according to the present embodiment.

The control unit 25 of the information processing apparatus 11C performs the processing of Steps S200 to S222 in a similar manner to Steps S300 to S322 (see FIG. 14) performed by the control unit 21 of the second embodiment.

Specifically, the display control unit 25A displays a condition setting screen 50A on the display unit 12A (Step S300). The acquisition unit 21B acquires condition setting information input via the condition setting screen 50A (Step S302). The management unit 21E registers, in a condition setting DB 14D, information indicating the entry device and the goal device included in the condition setting information acquired in Step S302 (Step S304).

The management unit 21E clears all pieces of information registered in the verification result DB 17F and registers information “NULL” indicating attack countermeasure information “none” in the field of the attack countermeasure information in the verification result DB 17F (Step S306). The setting unit 21F acquires verification target system definition information 14A stored in the storage unit 17 (Step S308) and sets it as the verification environment definition information 14E (Step S310). The construction unit 21G constructs the verification environment 40 by using the verification environment definition information 14E set in Step S310 (Step S312).

Next, the verification unit 25H specifies the entry device and the goal device indicated by the condition setting information registered in the condition setting DB 14D in Step S304. Then, the verification unit 25H specifies a plurality of attack scenarios corresponding to a combination of the specified entry device and the specified goal device from an attack scenario DB 17B (Step S314). Then, the verification unit 25H performs an attack having an attack content represented by an attack scenario on the verification environment 40 constructed by the construction unit 21G for each of the plurality of attack scenarios specified in Step S314 (Step S316). Then, in a case where the attack has reached the goal device, the verification unit 25H holds the attack scenario as an attack scenario in which the attack has succeeded.

Then, once the execution of all of the plurality of specified attack scenarios is completed, the verification unit 25H creates the possible attack scenario list that is a list of attack scenarios in which the attack has succeeded (Step S318). It is sufficient if the verification unit 25H performs an attack having an attack content represented by an attack scenario on the verification environment 40 in a similar manner to that of the verification unit 21H of the above-described embodiment, and creates the possible attack scenario list in a similar manner to that of the verification unit 21H. However, in the present embodiment, the verification unit 25H creates, as the possible attack scenario list, a list of a plurality of severity-added attack scenarios each including an attack scenario in which the attack has succeeded and the severity of the attack scenario.

The management unit 21E registers the possible attack scenario list created in Step S318 and the verification environment definition information 14E of the verification environment 40 verified in Step S316 in the verification result DB 15F in association with each other (Step S320).

Next, the management unit 21E determines whether or not the attack countermeasure information 14C1 has been registered in association with the verification environment definition information 14E registered in the verification result DB 17F in Step S320 (Step S322). In a case where it is determined that the verification environment 40 indicated by the verification environment definition information 14E registered in the verification result DB 15F is not the verification environment to which the attack countermeasure is applied (Step S322: No), the processing proceeds to Step S324.

In Step S324, the risk calculation unit 25D calculates the risk value by using the severity for each attack countermeasure represented by the attack countermeasure information 14C1 registered in the verification result DB 17F by using the verification environment definition information 14E and the possible attack scenario list corresponding to each of all the attack countermeasure IDs registered in the verification result DB 17F (Step S324). With the processing of Step 324, the risk calculation unit 25D calculates the risk value corresponding to the severity of an attack scenario for each attack countermeasure.

For example, it is assumed that the risk calculation unit 25D calculates the verification environment 40 in which no attack countermeasure is applied, that is, the risk value for the attack countermeasure “none”. Then, it is assumed that the risk calculation unit 25D calculates the attack path number of “2” and the attack scenario number of “10” by using the verification environment definition information 14E and the possible attack scenario list. Then, it is assumed that, among 10 attack scenarios included in the possible attack scenario list, two attack scenarios have the severity of “10”, four attack scenarios have the severity of “6”, and four attack scenarios have the severity of “2”. In this case, the risk calculation unit 25D calculates, as the risk value, “10” which is the maximum value of the severity.

In addition, for example, it is assumed that the risk calculation unit 25D calculates the risk value for the attack countermeasure indicated by the attack countermeasure information 14C1 including the countermeasure content “Firewall” and the installation location “between HMI and frontend”. Then, it is assumed that the risk calculation unit 25D calculates the attack path number of “1” and the attack scenario number of “3” by using the verification environment definition information 14E and the possible attack scenario list. Then, it is assumed that, among three attack scenarios included in the possible attack scenario list, two attack scenarios have the severity of “2” and one attack scenario has the severity of “1”. In this case, the risk calculation unit 25D calculates, as the risk value, “2” which is the maximum value of the severity.

In addition, for example, it is assumed that the risk calculation unit 25D calculates the risk value for the attack countermeasure indicated by the attack countermeasure information 14C1 including the countermeasure content “IT-IDS” and the installation location “in frontend network”. Then, it is assumed that the risk calculation unit 25D calculates the attack path number of “2” and the attack scenario number of “7” by using the verification environment definition information 14E and the possible attack scenario list. Then, it is assumed that, among seven attack scenarios included in the possible attack scenario list, four attack scenarios have the severity of “2”, two attack scenarios have the severity of “6”, and one attack scenario has the severity of “10”. In this case, the risk calculation unit 25D calculates, as the risk value, “10” which is the maximum value of the severity.

The display control unit 25A generates the verification result screen 62A including the risk value and the installation cost for each attack countermeasure calculated in Step S324 and the attack path screen 61B for each attack countermeasure (Step S326). In addition, the display control unit 25A generates the selection screen 61C.

Then, the display control unit 21A displays the display screen 50 including the verification result screen 62A and the attack path screen 61B generated for each attack countermeasure in Step S326, and the selection screen 61C on the display unit 12A (Step S328). With the processing of Step S328, for example, the display unit 12A displays the display screen 50H illustrated in FIG. 18.

Then, the control unit 25 performs the processing of Steps S330 to S344 in a similar manner to Steps S230 to S244 (see FIG. 14) performed by the control unit 21 of the second embodiment.

Specifically, the acquisition unit 21B determines whether or not a plurality of pieces of attack countermeasure information 14C1 and the verification execution instruction have been acquired from the UI unit 12 (Step S330). In a case where a negative determination is made in Step S330 (Step S330: No), this routine ends. In a case where an affirmative determination is made in Step S330 (Step S330: Yes), the processing proceeds to Step S332. In Step 332, the management unit 21E clears all pieces of information registered in the verification result DB 17F (Step S332). Then, the management unit 21E registers each of the plurality of pieces of attack countermeasure information 14C1 input via the selection screen 61C in Step S330 in the field of the attack countermeasure information in the verification result DB 17F (Step S334). Then, the processing proceeds to Step S338 described later.

On the other hand, in a case where an affirmative determination is made in Step S322 (Step S322: Yes), the processing proceeds to Step S336. In Step S336, the management unit 21E determines whether or not the attack countermeasures indicated by all pieces of attack countermeasure information 14C1 registered in the verification result DB 17F have been verified (Step S336). In a case where an affirmative determination is made in Step S336 (Step S336: Yes), the processing proceeds to Step S324. In a case where a negative determination is made in Step S336 (Step S336: No), the processing proceeds to Step S338.

In Step S338, the management unit 21E acquires one piece of attack countermeasure information 14C1 for which the verification environment definition information 14E has not been registered from the verification result DB 17F (Step S338). Then, the management unit 21E clears all pieces of information set in the verification environment definition information 14E. Further, the setting unit 21F acquires the verification target system definition information 14A from the storage unit 17 (Step S340). Then, the setting unit 21F sets the verification environment definition information 14E to which the attack countermeasure indicated by the attack countermeasure information 14C1 acquired in Step S338 is applied, in the verification target system definition information 14A acquired in Step S340 (Step S342).

Then, the construction unit 21G constructs the verification environment 40 by using the verification environment definition information 14E set in Step S342 (Step S344). Then, the processing returns to Step S214 described above.

As described above, in the information processing apparatus 11C according to the present embodiment, the risk calculation unit 25D calculates the risk value based on the attack scenario and the severity included in each of one or more severity-added attack scenarios included in the possible attack scenario list. Therefore, the information processing apparatus 11C according to the present embodiment can provide an attack scenario with a high risk in a manner that enables easy confirmation, in addition to achieving the effects of the above-described embodiment.

For example, it is assumed that the risk value for the attack countermeasure “none” is “20” as illustrated in FIG. 13A. Then, it is assumed that the risk value indicating the evaluation result of attack countermeasure (1) is “10” as illustrated in FIG. 18. In this case, the user can confirm that the effect of attack countermeasure (1) is higher than that of the attack countermeasure “none” by viewing the display screen 50. Furthermore, it is assumed that the risk value for attack countermeasure (2) is “30” and the risk value for attack countermeasure (3) is “15” as illustrated in FIG. 18. In this case, the user can easily confirm that attack countermeasure (1) is the most effective attack countermeasure among attack countermeasures (1) to (3).

In addition, for example, it is assumed that the installation cost in a case where attack countermeasure (1) is applied is “5”, the installation cost in a case where attack countermeasure (2) is applied is “3”, and the installation cost in a case where attack countermeasure (3) is applied is “10” as illustrated in FIG. 18. In this case, the user can compare a correlation between the installation cost and the risk value by viewing the verification result screen 62A, and can find a cost-effective and effective attack countermeasure.

### Fourth Embodiment

In the above-described embodiment, a form in which the attack scenario DB and the attack countermeasure DB are stored in advance has been described as an example. In the present embodiment, a form in which the attack scenario DB and the attack countermeasure DB are created and used for processing will be described. Functions similar to those in the above-described embodiment are denoted by the same reference signs, and a detailed description thereof will be omitted.

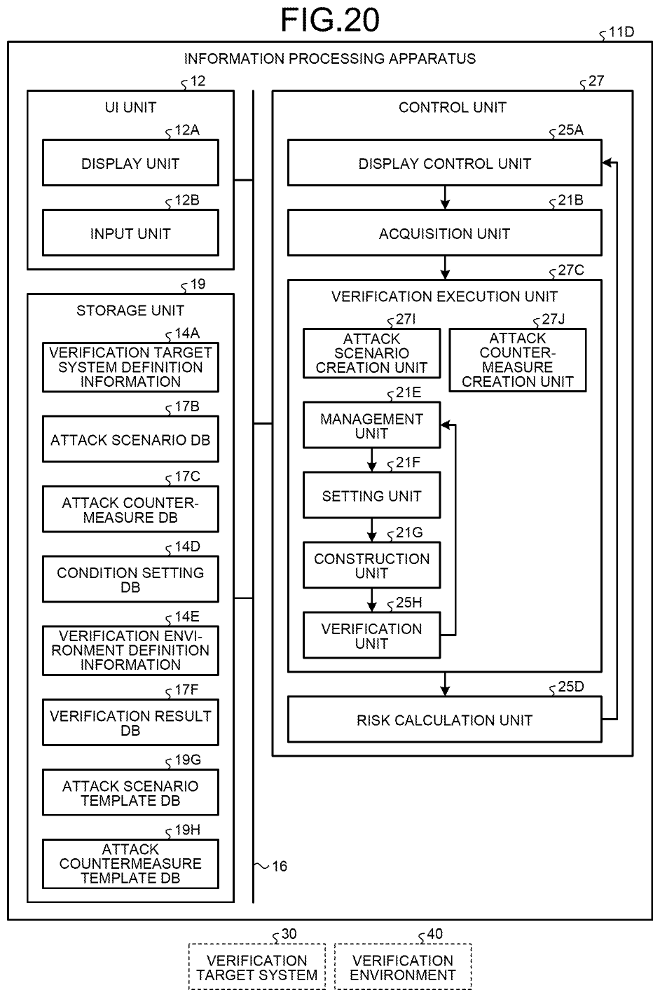

FIG. 20 is a schematic diagram of an example of an information processing apparatus 11D according to the present embodiment.

The information processing apparatus 11D includes a UI unit 12, a storage unit 19, and a control unit 27. The UI unit 12, the storage unit 19, and the control unit 27 are communicably connected via a bus 16 or the like. The UI unit 12 is similar to that of the above-described embodiment.

The storage unit 19 stores various types of information. The storage unit 19 further stores an attack scenario template DB 19G and an attack countermeasure template DB 19H in addition to the information stored in the storage unit 17 of the third embodiment. Details of the attack scenario template DB 19G and the attack countermeasure template DB 19H will be described later.

The control unit 27 performs information processing in the information processing apparatus 11D. The control unit 27 includes a display control unit 25A, an acquisition unit 21B, a verification execution unit 27C, and a risk calculation unit 25D. The verification execution unit 25C includes a management unit 21E, a setting unit 21F, a construction unit 21G, a verification unit 25H, an attack scenario creation unit 271, and an attack countermeasure creation unit 27J.

The control unit 27 is similar to the control unit 25 of the above-described embodiment except that the verification execution unit 27C is included instead of the verification execution unit 25C. The verification execution unit 27C is similar to the verification execution unit 25C of the above-described embodiment except that the attack scenario creation unit 271 and the attack countermeasure creation unit 27J are further included.

The attack scenario creation unit 271 creates an attack scenario based on verification target system definition information 14A of a verification target system 30 and an attack scenario template.

The attack scenario template is a template in which a setting item of an attack scenario is defined. The attack scenario template is registered in advance in the attack scenario template DB 19G.

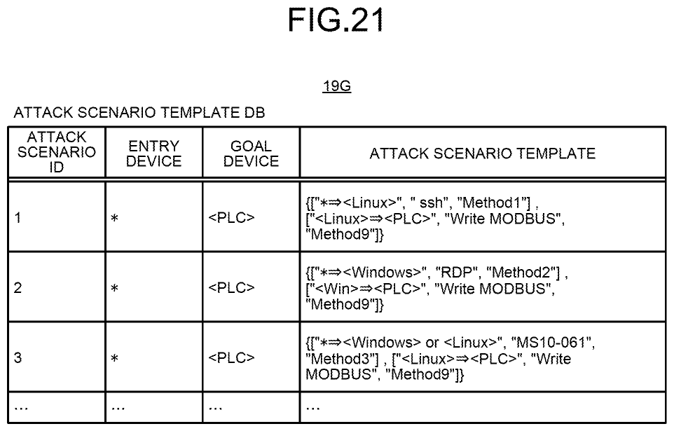

FIG. 21 is a schematic diagram of an example of a data configuration of the attack scenario template DB 19G.

In the attack scenario template DB 19G, templates of a plurality of attack scenarios are registered in advance. For example, the attack scenario template is information in which an attack scenario ID, an entry device, a goal device, and an attack scenario template are associated with each other.

The attack scenario ID is identification information of a corresponding attack scenario template. In the attack scenario template DB 19G, “*” means all device types. In the attack scenario template DB 19G, “<A>” means device type A.

In the example illustrated in FIG. 21, for example, an attack countermeasure template, in which an attack scenario template of an attack scenario in which the entry device is “*”, the goal device is “<PLC>”, the attack means “ssh” and the attack method “Method11” are used for the attack from a device of an arbitrary device type toward a device of a device type “Linux (registered trademark)”, and then the attack means “Write MODBUS” and the attack method “Method91” are used for the attack from the device of the device type “Linux” to a device of a device type “PLC”, and the severity of “10” are associated with each other, is registered in the attack scenario template DB 19G. Note that the severity is omitted in FIG. 21.

Then, the attack scenario creation unit 271 creates an attack scenario based on the attack scenario template registered in the attack scenario template DB 19G and the verification target system definition information 14A of the verification target system 30.

Specifically, the attack scenario creation unit 271 specifies the entry device and the goal device indicated by condition setting information registered in a condition setting DB 14D. Then, the attack scenario creation unit 271 specifies an attack scenario template corresponding to each combination of the entry device, the goal device, and the device type included in the verification target system definition information 14A from the attack scenario template DB 19G by using the specified entry device and goal device, and the verification target system definition information 14A. Then, the attack scenario creation unit 271 creates an attack scenario in which a device ID is set for the specified attack scenario template, and registers the attack scenario in an attack scenario DB 14B.

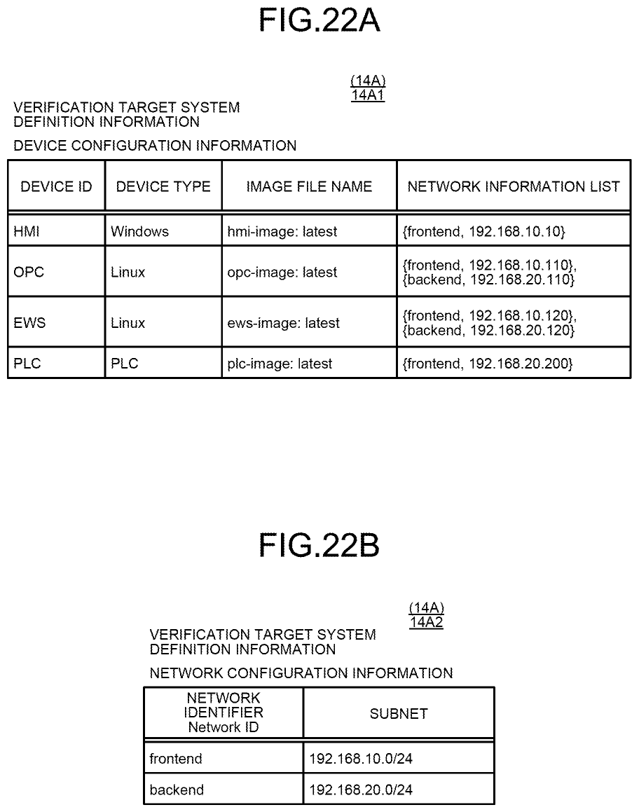

For example, it is assumed that the storage unit 19 stores the verification target system definition information 14A illustrated in FIGS. 22A and 22B as information indicating the definition of the verification target system 30.

FIGS. 22A and 22B are schematic diagrams illustrating examples of a data configuration of the verification target system definition information 14A. FIG. 22A is a schematic diagram illustrating an example of a data configuration of device configuration information 14A1 included in the verification target system definition information 14A. FIG. 22B is a schematic diagram illustrating an example of a data configuration of network configuration information 14A2 included in the verification target system definition information 14A.

In addition, it is assumed that the entry device and the goal device indicated by the condition setting information registered in the condition setting DB 14D are the entry device “HMI” and the goal device “PLC”. Then, as illustrated in FIGS. 22A and 22B, in the verification target system 30, the device type corresponding to the device ID “OPC” is “Linux”, “HMI” and “OPC” are directly connected by a “frontend” network, and “OPC” and “PLC” are directly connected by a “backend” network. Therefore, the pattern of the device configuration and the network configuration of the verification target system 30 matches the pattern of the attack scenario template in the first row in the attack scenario template DB 19G.

Therefore, the attack scenario creation unit 271 inserts “HMI” into “*” included in the attack scenario template in the first row in the attack scenario template DB 19G, and inserts “PLC” into “<PLC>”. In addition, the attack scenario creation unit 271 replaces “<Linux>” of the attack scenario template with “OPC”. With these processings, the attack scenario creation unit 271 creates an attack scenario and stores the attack scenario in the attack scenario DB 14B. For example, the attack scenario creation unit 271 generates the attack scenario described in the first row in the attack scenario DB 14B in FIG. 3C.

As described above, the attack scenario creation unit 271 creates an attack scenario based on the attack scenario template registered in the attack scenario template DB 19G and the verification target system definition information 14A of the verification target system 30, and stores the attack scenario in the attack scenario DB 14B.

Returning to FIG. 20, the description will be continued. The attack countermeasure creation unit 27J creates attack countermeasure information based on the verification target system definition information 14A and the attack countermeasure template.

The attack countermeasure template is a template in which a setting item of an attack countermeasure is defined. The attack countermeasure template is registered in advance in the attack countermeasure template DB 19H.

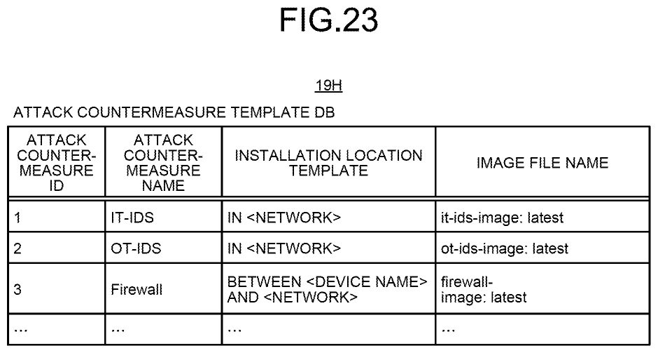

FIG. 23 is a schematic diagram of an example of a data configuration of the attack countermeasure template DB 19H.

The attack countermeasure template DB 19H includes a plurality of attack countermeasure templates in advance. For example, the attack countermeasure template is information in which an attack countermeasure ID, an attack countermeasure name, an installation location template, and an image file name are associated with each other. The attack countermeasure ID is identification information of an attack countermeasure. The installation location template is a template representing an installation location of an attack countermeasure.

In the attack countermeasure template DB 19H, “<device name>” means a device name. In the present embodiment, the device name matches a device ID (see FIG. 3A and the like). “<Network>” means a network name. In the present embodiment, the network name matches a network ID (see also FIG. 3B and the like).

In the example illustrated in FIG. 23, the attack countermeasure template DB 19H includes, for example, an attack countermeasure in which the attack countermeasure ID is “3”, the attack countermeasure name is “Firewall”, the installation location template is “between <device name> and <network>”, and the image file name is “firewall-image:latest”.

The attack countermeasure creation unit 27J acquires a plurality of attack countermeasure templates registered in the attack countermeasure template DB 19H. Then, the attack countermeasure creation unit 27J creates attack countermeasure information 14C1 of the attack countermeasure by using the verification target system definition information 14A and each of the plurality of attack countermeasure templates, and registers the attack countermeasure information 14C1 in an attack countermeasure DB 14C.

For example, it is assumed that the storage unit 19 stores the verification target system definition information 14A illustrated in FIGS. 22A and 22B as information indicating the definition of the verification target system 30.

In this case, the attack countermeasure creation unit 27J creates the attack countermeasure information 14C1 of the attack countermeasure by performing the following processing for the attack countermeasure template including the attack countermeasure ID “1” registered in the attack countermeasure template DB 19H illustrated in FIG. 23.

As illustrated in FIGS. 22A and 22B, the verification target system 30 indicated by the verification target system definition information 14A has the frontend network and the backend network. Therefore, the attack countermeasure creation unit 27J creates attack countermeasure information 14C1 including the attack countermeasure name “IT-IDS”, the installation location “frontend network”, and the image file name “it-ids-image:latest”, and attack countermeasure information 14C1 including the attack countermeasure name “IT-IDS”, the installation location “backend network”, and the image file name “it-ids-image:latest”. Then, the attack countermeasure creation unit 27J assigns the attack countermeasure ID to each of the pieces of created attack countermeasure information 14C1 and registers the pieces of attack countermeasure information 14C1 in the attack countermeasure DB 14C. Therefore, for example, the storage unit 19 registers the attack countermeasure DB 14C illustrated in FIG. 3D.

Next, an example of a flow of the information processing performed by the information processing apparatus 11D according to the present embodiment will be described.

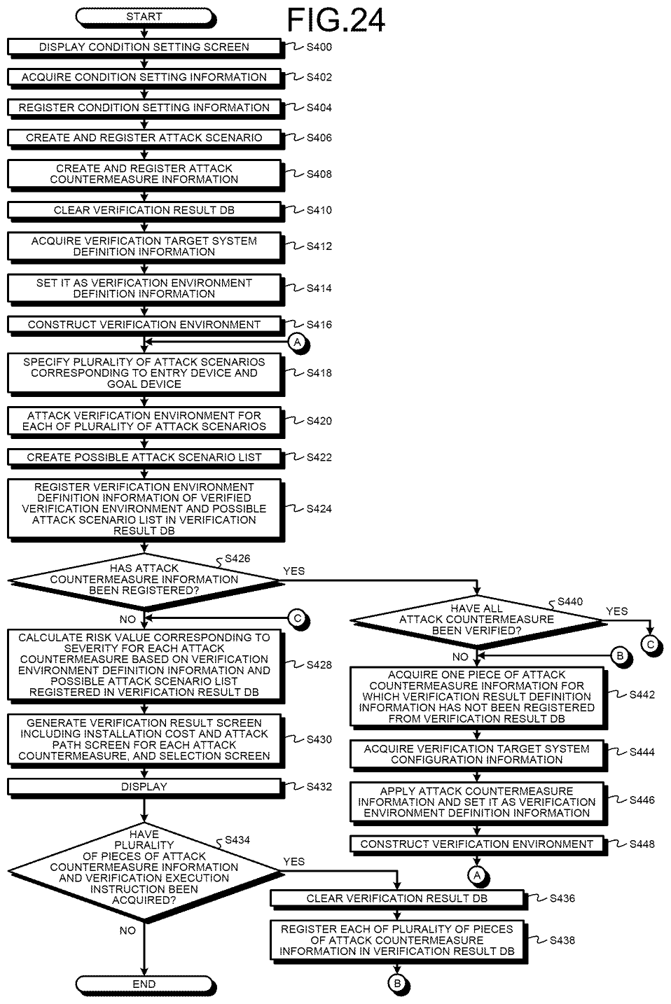

FIG. 24 is a flowchart illustrating an example of a flow of the information processing performed by the information processing apparatus 11D according to the present embodiment.

The control unit 27 of the information processing apparatus 11D performs the processing of Steps S300 to S304 in a similar manner to Steps S400 to S404 (see FIG. 19) performed by the control unit 25 of the third embodiment.

Specifically, the display control unit 25A displays a condition setting screen 50A on the display unit 12A (Step S400). The acquisition unit 21B acquires condition setting information input via the condition setting screen 50A (Step S402). The management unit 21E registers, in the condition setting DB 14D, information indicating the entry device and the goal device included in the condition setting information acquired in Step S402 (Step S404).

Next, the attack scenario creation unit 271 creates an attack scenario based on the attack scenario template registered in the attack scenario template DB 19G, the verification target system definition information 14A, and the condition setting information registered in the condition setting DB 14D. Then, the attack scenario creation unit 271 registers the created attack scenario in the attack scenario DB 14B (Step S406).

Next, the attack countermeasure creation unit 27J creates attack countermeasure information 14C1 based on the verification target system definition information 14A and the attack countermeasure template registered in the attack countermeasure template DB 19H. Then, the attack countermeasure creation unit 27J registers the created attack countermeasure information 14C1 in the attack countermeasure DB 14C (Step S408).

With the processing of Steps S406 and S408, the attack scenario creation unit 271 creates an attack scenario and registers the attack scenario in the attack scenario DB 14B, and the attack countermeasure creation unit 27J creates attack countermeasure information 14C1 and registers the attack countermeasure information 14C1 in the attack countermeasure DB 14C.

Then, the control unit 27 of the information processing apparatus 11D performs the processing of Steps S306 to S344 in a similar manner to Steps S410 to S448 (see FIG. 19) performed by the control unit 25 of the third embodiment.

As described above, in the information processing apparatus 11D according to the present embodiment, the attack scenario creation unit 271 creates an attack scenario based on the verification target system definition information 14A of the verification target system 30 and the attack scenario template in which a setting item of the attack scenario is defined. The attack scenario creation unit 271 creates attack countermeasure information 14C1 based on the verification target system definition information 14A and the attack countermeasure template in which a setting item of the attack countermeasure information 14C1 is defined. Then, the information processing apparatus 11D uses an attack scenario DB 17B in which the created attack scenario is registered and an attack countermeasure DB 17C in which the created attack countermeasure information 14C1 is registered to perform processing similar to that of the above-described embodiment.

Therefore, the information processing apparatus 11D according to the present embodiment can verify the verification target system 30 by using an attack scenario and an attack countermeasure suitable for the verification target system 30.

Note that, in the present embodiment, a form in which the verification execution unit 27C creates an attack scenario and attack countermeasure information 14C1 based on the verification target system definition information 14A has been described as an example. However, the verification execution unit 27C may create the attack scenario and the attack countermeasure information 14C1 based on the verification environment definition information 14E. Since the verification execution unit 27C creates the attack scenario based on the verification environment definition information 14E, it is possible to create an attack scenario that occurs only in a case where the attack countermeasure is applied. In addition, as the verification execution unit 27C creates the attack countermeasure information 14C1 based on the verification environment definition information 14E, it is also possible to create the attack countermeasure information 14C1 of an attack countermeasure for preventing further attack against a specific attack countermeasure.

Next, an example of a hardware configuration of the information processing apparatus 10, the information processing apparatus 11B, the information processing apparatus 11C, and the information processing apparatus 11D of the above-described embodiments will be described.

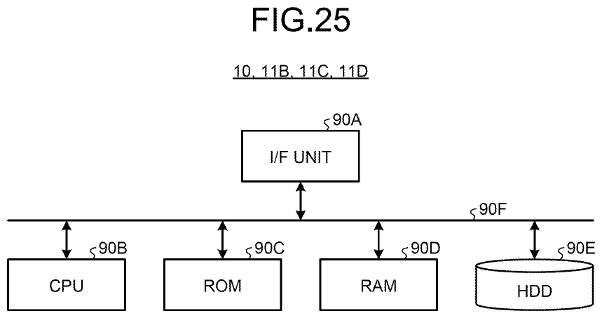

FIG. 25 is a diagram illustrating an example of the hardware configuration of the information processing apparatus 10, the information processing apparatus 11B, the information processing apparatus 11C, and the information processing apparatus 11D of the above-described embodiments.

The information processing apparatus 10, the information processing apparatus 11B, the information processing apparatus 11C, and the information processing apparatus 11D of the above-described embodiments each include a control device such as a central processing unit (CPU) 90B, a storage device such as a read only memory (ROM) 90C, a random access memory (RAM) 90D, or a hard disk drive (HDD) 90E, an I/F unit 90A that is an interface with various devices, and a bus 90F that connects the respective units, and have a hardware configuration using a normal computer.

In the information processing apparatus 10, the information processing apparatus 11B, the information processing apparatus 11C, and the information processing apparatus 11D of the above-described embodiments, the CPU 90B reads a program from the ROM 90C onto the RAM 90D and executes the program, whereby the above-described respective units are implemented on a computer.

Note that the program for performing each of the above-described processings performed by the information processing apparatus 10, the information processing apparatus 11B, the information processing apparatus 11C, and the information processing apparatus 11D of the above-described embodiments may be stored in the HDD 90E. Furthermore, the program for performing each of the above-described processings performed by the information processing apparatus 10, the information processing apparatus 11B, the information processing apparatus 11C, and the information processing apparatus 11D of the above-described embodiments may be provided by being incorporated in the ROM 90C in advance.

Furthermore, the program for performing the above-described processings performed by the information processing apparatus 10, the information processing apparatus 11B, the information processing apparatus 11C, and the information processing apparatus 11D of the above-described embodiments may be stored in a computer-readable storage medium such as a CD-ROM, a CD-R, a memory card, a digital versatile disc (DVD), or a flexible disk (FD) as a file in an installable format or an executable format, and may be provided as a computer program product. Furthermore, the program for performing the above-described processings performed by the information processing apparatus 10, the information processing apparatus 11B, the information processing apparatus 11C, and the information processing apparatus 11D of the above-described embodiments may be stored on a computer connected to a network such as the Internet and be provided by being downloaded via the network. Furthermore, the program for performing the above-described processings performed by the information processing apparatus 10, the information processing apparatus 11B, the information processing apparatus 11C, and the information processing apparatus 11D of the above-described embodiments may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a verification execution unit that attacks a verification environment in which at least one of attack countermeasures indicated by attack countermeasure information is applied to a verification target system by using each of a plurality of attack scenarios, and creates a possible attack scenario list that is a list of attack scenarios in which an attack has succeeded; and
a risk calculation unit that calculates a risk value representing an evaluation result of the attack countermeasure applied to the verification environment, based on the possible attack scenario list.

2. The apparatus according to claim 1, further comprising
a display control unit that displays a verification result screen including the risk value.

3. The apparatus according to claim 2, wherein
the display control unit displays the verification result screen including the risk value and at least one of a applied countermeasures number which is a number of attack countermeasures applied to the verification environment, an attack path number which is a number of attack paths through which an attack on the verification environment has succeeded, and an attack scenario number which is a number of attack scenarios in which an attack has succeeded.

4. The apparatus according to claim 2, wherein
the display control unit displays an attack path screen including at least one of:
a configuration image of the verification environment including at least one of device configuration information of the verification environment, a network configuration of the verification environment, and the attack countermeasure applied to the verification environment;
a successful attack path image of an attack path through which an attack indicated by the possible attack scenario list has succeeded; and
an attack procedure along the attack path through which the attack has succeeded.

5. The apparatus according to claim 2, wherein
the display control unit displays a selection screen for the attack countermeasure information including an attack countermeasure name of the attack countermeasure and an installation location of the attack countermeasure for the verification target system, and
the verification execution unit constructs the verification environment to which the attack countermeasure indicated by the attack countermeasure information is applied based on the attack countermeasure information selected via the selection screen.

6. The apparatus according to claim 1, wherein
the verification environment includes a plurality of verification environments, the attack countermeasure information includes a plurality of pieces of attack countermeasure information, the possible attack scenario list includes possible attack scenario lists, the risk value includes risk values,
the verification execution unit attacks the plurality of verification environments to which, for each of the plurality of pieces of attack countermeasure information, an attack countermeasure indicated by the attack countermeasure information is applied, and creates the possible attack scenario lists for each of the plurality of verification environments, and
the risk calculation unit calculates the risk values for each of the attack countermeasures, based on the possible attack scenario lists.

7. The apparatus according to claim 2, wherein
the risk value includes risk values, and
the display control unit displays the verification result screen including the risk values for each of the attack countermeasures.

8. The apparatus according to claim 1, wherein
the verification execution unit creates the possible attack scenario list that is a list of a plurality of severity-added attack scenarios including attack scenarios in which the attack has succeeded and severities of the attack scenarios, and
the risk calculation unit calculates the risk value based on an attack scenario and a severity included in each of one or more of the severity-added attack scenarios included in the possible attack scenario list.

9. The apparatus according to claim 2, wherein
the display control unit displays the verification result screen further including an installation cost indicating a cost required for installation and operation of the attack countermeasure.

10. The apparatus according to claim 1, wherein
the verification execution unit includes an attack scenario creation unit that creates the attack scenarios, based on verification target system definition information of the verification target system or verification environment definition information of the verification environment, and attack scenario templates in which a setting item of the attack scenarios is defined.

11. The apparatus according to claim 10, wherein
the verification execution unit further includes an attack countermeasure creation unit that creates the attack countermeasure information based on the verification target system definition information or the verification environment definition information and attack countermeasure templates in which a setting item of the attack countermeasure information is defined.

12. A computer program product comprising a computer-readable medium including programmed instructions, the instructions causing a computer to perform:
attacking a verification environment in which at least one of attack countermeasures indicated by attack countermeasure information is applied to a verification target system by using each of a plurality of attack scenarios, and creating a possible attack scenario list that is a list of the attack scenarios in which an attack has succeeded; and
calculating a risk value representing an evaluation result of the attack countermeasure applied to the verification environment, based on the possible attack scenario list.

13. An information processing apparatus comprising:
a verification execution unit that attacks a verification environment in which at least one of attack countermeasures indicated by attack countermeasure information is applied to a verification target system by using each of a plurality of attack scenarios, and creates a possible attack scenario list that is a list of the attack scenarios in which an attack has succeeded;
a risk calculation unit that calculates a risk value representing an evaluation result of the attack countermeasure applied to the verification environment, based on the possible attack scenario list;
a display unit; and
a display control unit that displays a verification result screen including the risk value on the display unit.
